(19) United States
(12) Patent Application Publication
(10) Pub. No.: US 2024/0253924 A1
(43) Pub. Date: Aug. 1, 2024

(54) SHEET PROCESSING APPARATUS

(71) Applicant: GLORY LTD., Hyogo (JP)

(72) Inventors: Yoshitomo MINAMI, Hyogo (JP); Aya KANO, Hyogo (JP)

(21) Appl. No.: 18/420,872

(22) Filed: Jan. 24, 2024

(30) Foreign Application Priority Data
Jan. 27, 2023 (JP) 2023-011025

(51) Int. Cl. B65H 7/06; B65H 5/02; B65H 5/06; B65H 5/36; B65H 9/00

(52) U.S. Cl. CPC B65H 7/06; B65H 5/021; B65H 5/36; B65H 9/002; B65H 5/06; B65H 2301/16; B65H 2301/33; B65H 2701/1912

(57) ABSTRACT

A sheet processing apparatus according to the present disclosure includes: an inlet configured to receive a sheet; an outlet configured to eject the sheet; a conveyance mechanism configured to convey the sheet between the inlet and the outlet; a recognition unit configured to recognize the sheet; and at least one recycling chamber configured to store the sheet. The conveyance mechanism includes a first conveyance mechanism configured to convey downward the sheet received from the inlet, and a second conveyance mechanism connecting between the first conveyance mechanism and the outlet and configured to convey upward the sheet conveyed from the first conveyance mechanism. The recognition unit is disposed on a conveyance path on which the sheet is conveyed by the first conveyance mechanism. The at least one recycling chamber is connected to the second conveyance mechanism.

### CROSS REFERENCE TO RELATED APPLICATIONS

This application is entitled to and claims the benefit of Japanese Patent Application No. 2023-011025, filed on Jan. 27, 2023, the disclosure of which including the specification, drawings and abstract is incorporated herein by reference in its entirety.

### TECHNICAL FIELD

The present disclosure relates to a sheet processing apparatus.

### BACKGROUND ART

In the related art, a depositing/dispensing apparatus that performs a process of depositing and dispensing sheets such as banknotes is known. The depositing/dispensing apparatus includes an operation unit including a depositing unit and a dispensing unit, a banknote conveyance unit, a banknote recognition unit, a stacking unit, and a collection chamber. The banknote conveyance unit includes a banknote conveyance path where the banknote inserted from the depositing unit passes through the banknote recognition unit. The conveyance path is connected to the collection chamber provided at the lowermost portion of the apparatus, and further extends from the collection chamber to a stacking unit in an upper portion. The banknote conveyance path has a diversion between the depositing unit and the banknote recognition unit, and extends to the dispensing unit.

### SUMMARY

A sheet processing apparatus comprises: an inlet configured to receive a sheet; an outlet configured to eject the sheet; a conveyance mechanism configured to convey the sheet between the inlet and the outlet; a recognition unit configured to recognize the sheet; and at least one recycling chamber configured to store the sheet. The conveyance mechanism comprises a first conveyance mechanism configured to convey downward the sheet received from the inlet, and a second conveyance mechanism connecting between the first conveyance mechanism and the outlet and configured to convey upward the sheet conveyed from the first conveyance mechanism. The recognition unit is disposed on a conveyance path on which the sheet is conveyed by the first conveyance mechanism. The at least one recycling chamber is connected to the second conveyance mechanism.

### BRIEF DESCRIPTION OF DRAWINGS

FIG. 1 is a diagram illustrating a basic configuration of a sheet processing apparatus according to a first embodiment;

FIG. 2 is a side view illustrating an internal configuration of the sheet processing apparatus;

FIG. 3 is a block diagram illustrating a functional configuration of the sheet processing apparatus;

FIG. 4 is a diagram illustrating an example of division of a drive system of the sheet processing apparatus;

FIG. 5 is a diagram illustrating an example of division of a drive system of a sheet processing apparatus according to a second embodiment;

FIG. 6 is a diagram for describing a timing of switching of a diversion mechanism;

FIG. 7 is a flowchart illustrating a method of depositing a banknote by using the sheet processing apparatus according to the second embodiment;

FIG. 8A is a flowchart illustrating a method of dispensing a banknote by using the sheet processing apparatus according to the second embodiment;

FIG. 8B is a flowchart illustrating a method of dispensing a banknote by using the sheet processing apparatus according to the second embodiment;

FIG. 9 is a diagram illustrating an example case where how a banknote is conveyed in a dispensing process;

FIG. 10A is a flowchart illustrating a method of dispensing a banknote by using a sheet processing apparatus according to a third embodiment;

FIG. 10B is a flowchart illustrating a method of dispensing a banknote by using the sheet processing apparatus according to the third embodiment;

FIG. 11 is a diagram illustrating an example case where how a banknote is conveyed in a dispensing process;

FIG. 12A is a flowchart illustrating a method of depositing a banknote by using a sheet processing apparatus according to a fourth embodiment;

FIG. 12B is a flowchart illustrating a method of depositing a banknote by using the sheet processing apparatus according to the fourth embodiment;

FIG. 13A is a flowchart illustrating a method of dispensing a banknote by using the sheet processing apparatus according to the fourth embodiment;

FIG. 13B is a flowchart illustrating a method of dispensing a banknote by using the sheet processing apparatus according to the fourth embodiment;

FIG. 14 is a diagram illustrating an example case where how a banknote is conveyed in a dispensing process; and

FIG. 15 is a diagram for describing a detection of a left/right deviation of a banknote with a sensor.

### DESCRIPTION OF EMBODIMENTS

A sheet processing apparatus that can perform a conveyance in accordance with the recognition result through a simple control is desired.

An object of the present disclosure is to provide a downsized sheet processing apparatus that can perform a conveyance in accordance with the recognition result through a simple control.

The recognition unit and the at least one recycling chamber may be disposed at positions that differ in the height direction.

The recognition unit may be disposed at a position higher than the at least one recycling chamber.

A three-direction diversion mechanism configured to convey the sheet with a diversion in a horizontal direction from the second conveyance mechanism may be provided, and the three-direction diversion mechanism may be connected to one of the at least one recycling chamber.

A collection chamber configured to store a sheet that is not used for dispensing may be provided, the collection chamber being located below the inlet, the outlet, the conveyance mechanism, the recognition unit, and the at least one recycling chamber.

The first conveyance mechanism may be disposed on a depth side of the sheet processing apparatus, and the second conveyance mechanism may be disposed on a near side.

A horizontal conveyance mechanism connecting between the inlet and the first conveyance mechanism may be provided.

A three-direction diversion mechanism disposed between the at least one recycling chamber and the second conveyance mechanism, and configured for diversion of the sheet may be provided.

The diversion of the sheet may be performed by the three-direction diversion mechanism such that the diversion is switched based on a conveyance destination of a next sheet in response to detection of passage of a previously conveyed sheet. Regarding the detection of passage of the sheet, a sensor provided at the conveyance mechanism detects the passage of the rear end of the sheet in response to light transmission occurred again after light-shielding with the sheet.

A plurality of recycling chambers may be provided in which each of the plurality of recycling chambers is connected to one three-direction diversion mechanism, and connected to the second conveyance mechanism.

A control unit may be provided that is configured to feed and convey one sheet from the at least one recycling chamber to the recognition unit, and stop conveyance of the sheet after the sheet passes through the recognition unit when reconciliation of the sheet stored in the at least one recycling chamber is performed. The first conveyance mechanism may include a third conveyance mechanism connecting between the inlet and the recognition unit, and the control unit may stop the driving of the third conveyance mechanism after the sheet passes through the recognition unit past.

The drive system may be divided by a third conveyance mechanism for conveyance from the inlet to the recognition unit, and a fourth conveyance mechanism for conveyance from the recognition unit and the recognition unit to the storage unit.

In the reconciliation process for the sheet stored in the recycling chamber, the control unit may drive each conveyance mechanism from the storage unit to the recognition unit, and from the recognition unit to the inlet, and stop the driving of the third conveyance mechanism after passage through the recognition unit. At this time, the driving of the fourth conveyance mechanism may be continued. After reception of the recognition result, the control unit may again drive the third conveyance mechanism to convey the banknote to a predetermined conveyance destination.

In the reconciliation of the sheet stored in the first recycling chamber, the control unit may feed one sheet from first recycling chamber and convey it to the recognition unit, and, stop the conveyance of the sheet after the sheet passes through the recognition unit.

A plurality of storage chambers including the at least one recycling chamber may be provided, and the control unit may be configured to store sheets of a first denomination and a second denomination in a first recycling chamber of the at least one recycling chamber, and when the sheet of the second denomination is inserted from the inlet, and a predetermined number or more of sheets of the second denomination are stored at a head in the first recycling chamber, the control unit may convey the inserted sheet of the second denomination to a collection chamber configured to store the sheet that is not used for dispensing.

When dispensing the sheet to the outlet, the control unit may convey a sheet of a denomination that is unnecessary for the dispensing from the first recycling chamber to a storage chamber that is different from the first recycling chamber. At this time, the storage chamber different from the first recycling chamber may be a collection chamber.

The first recycling chamber different from storage chamber may be a collection chamber configured to store the sheet that is not used for dispensing.

The storage chamber different from the first recycling chamber may be a second recycling chamber configured to store the sheet of the third denomination in a recyclable manner.

The control unit can store sheets of the first denomination and second denomination in the first recycling chamber of at least one recycling chamber, store sheets of the second denomination and third denomination in another recycling chamber of at least one recycling chamber. When the sheet of the second denomination is inserted from the inlet, the control unit may convey the inserted sheet of the second denomination to the other recycling chamber in the case where the sheet of the second denomination is not stored at the head in the first recycling chamber and the sheet of the second denomination is stored at the head in the other recycling chamber. When the sum of the number of sheets of the second denomination stored at the head in first and second recycling chambers is greater than a predetermined number, the control unit may convey the deposited sheet of the second denomination to the collection chamber. When dispensing from the second recycling chamber to the outlet, the control unit may convey the sheet of the denomination unnecessary for the dispensing from the second recycling chamber to the storage chamber different from the second recycling chamber.

When dispensing the sheet of the second denomination to the outlet, the control unit may convey the sheet of the second denomination to the outlet from the first recycling chamber or other recycling chambers.

When dispensing the sheet of the second denomination to the outlet, the control unit may dispense it from the recycling chamber of which the number of sheets of the second denomination located at the head is larger among the plurality of recycling chambers.

In the case where the dispensing frequency of the first denomination is higher than that of the third denomination, the control unit may dispense the sheet of the second denomination first from the other recycling chamber that stores the sheets of the third denomination among the plurality of recycling chambers when dispensing the sheet of the second denomination to the outlet.

According to the present disclosure, the sheet processing apparatus can be downsized, and a conveyance in accordance with the recognition result can be performed through a simple control.

Embodiments for implementing the sheet processing apparatus of the present disclosure are described below with reference to the attached drawing.

### First Embodiment

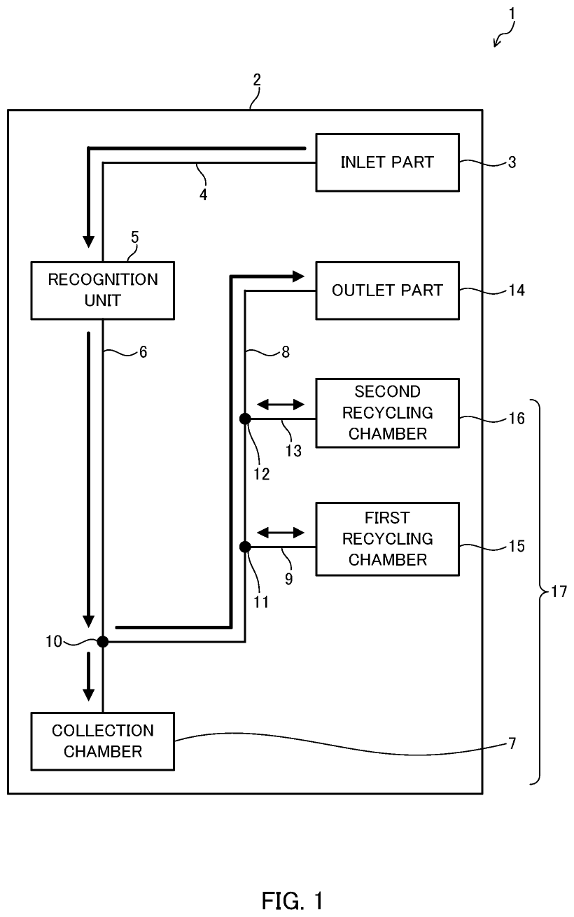

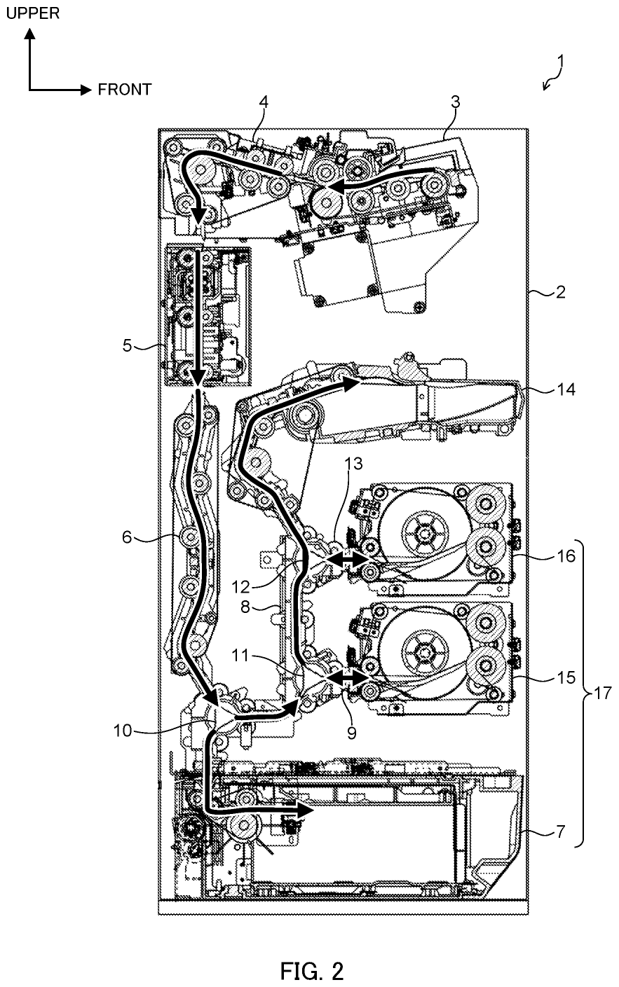

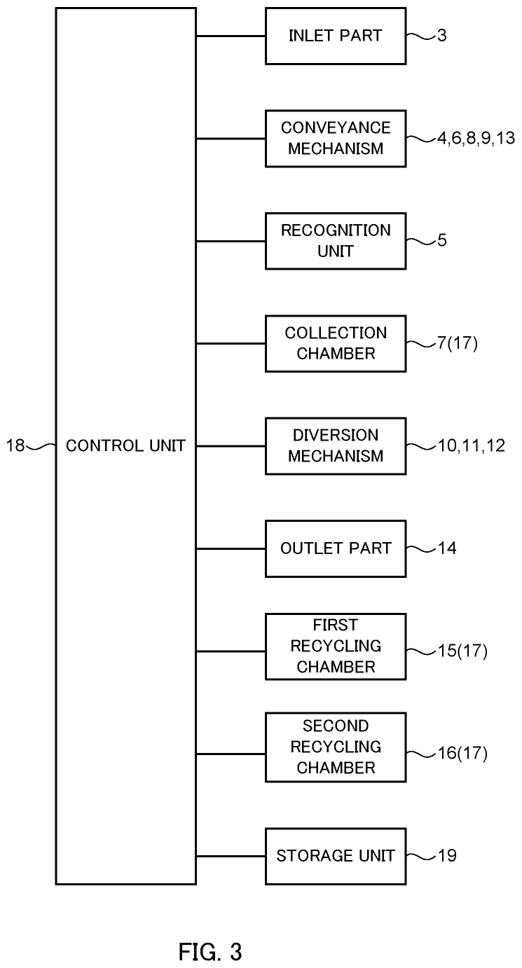

A first embodiment is described below with reference to the attached drawings. FIG. 1 is a diagram illustrating a basic configuration of a sheet processing apparatus according to the first embodiment, FIG. 2 is a diagram illustrating an internal configuration of the sheet processing apparatus, and FIG. 3 is a block diagram illustrating a functional configuration of the sheet processing apparatus. Note that the arrow in FIGS. 1 and 2 indicates an actual movement of sheets in a depositing process or a dispensing process.

A sheet processing apparatus 1 performs a depositing process, a dispensing process, and a reconciliation process of sheets such as banknotes. The following describes a case where the sheet is a banknote. Note that the sheet processing apparatus 1 can perform the depositing process of banknotes of several types while it can perform the dispensing process of recycle banknotes of two types (two-denomination mode). Banknotes of denominations that are not set for recycling may also be deposited, and when a banknote of a denomination not set for recycling is deposited it is directly conveyed to the collection chamber.

The sheet processing apparatus 1 includes a housing 2, an inlet part 3, a conveyance mechanism 4, a recognition unit 5, a conveyance mechanism 6, a collection chamber 7, a conveyance mechanism 8, a conveyance mechanism 9, a diversion mechanism 10, a diversion mechanism 11, a diversion mechanism 12, a conveyance mechanism 13, an outlet part 14, a first recycling chamber 15, a second recycling chamber 16, a control unit 18, and a storage medium 19. The collection chamber 7, the first recycling chamber 15, and the second recycling chamber 16 are collectively referred to as storage unit 17.

The housing 2 houses parts making up the sheet processing apparatus 1, and has a substantially cuboid shape.

The inlet part 3 is a part for receiving banknotes. The inlet part 3 is provided at the front upper part (in FIG. 2, the right upper part) of the housing 2. The inlet part 3 includes a mechanism for taking banknotes one by one into the apparatus. The user inputs banknotes to the inlet part 3.

The conveyance mechanism 4 conveys to the recognition unit 5 the banknote input to the inlet part 3. The conveyance mechanism 4 is provided at a position on the rear side of the inlet part 3 at substantially the same height as the inlet part 3. The conveyance mechanism 4 horizontally conveys the banknote coming from the inlet part 3, and then changes the conveyance direction in the vicinity of the rear surface of the housing 2 to convey it perpendicularly to the recognition unit 5 disposed on the lower side.

The conveyance mechanism 4 is composed of a combination of a plurality of rollers, a plurality of belts, their drive motors, and a plurality of guides. Note that a portion for horizontally conveying banknotes in the conveyance mechanism 4 makes up a horizontal conveyance mechanism. A part for perpendicularly conveying banknotes in the conveyance mechanism 4 makes up a part of a first conveyance mechanism.

The recognition unit 5 recognizes the banknote conveyed from the conveyance mechanism 4. The recognition unit 5 is provided above the second recycling chamber 16 at the rear surface of the housing 2. The recognition unit 5 includes at least any one of sensors such as an image sensor, an optical sensor, a magnetic sensor, and acquires the image of each banknote to recognize the authentication, denomination and the like. The recognition unit 5 also acquires the serial number of the banknote. It may also recognize the fitness of the banknote.

The conveyance mechanism 6 conveys the banknote conveyed from the recognition unit 5 to the lower side, or more specifically to the collection chamber 7 and the conveyance mechanism 8. Note that the switching of the conveyance of the banknote between the collection chamber 7 and the conveyance mechanism 8 is performed by the diversion mechanism 10 provided in the conveyance mechanism 6.

The conveyance mechanism 6 is provided on the back side of the housing 2 below the recognition unit 5 and above the collection chamber 7. The conveyance mechanism 6 is composed of a combination of a plurality of rollers, a plurality of belts, their drive motors, and a plurality of guides. Note that the conveyance mechanism 6 makes up a part of the first conveyance mechanism. Note that the conveyance mechanism 6 can also convey banknotes from the lower side to the upper side.

The collection chamber 7 collects banknotes not used for recycling conveyed from the conveyance mechanism 6 via the recognition unit 5. Here, the banknotes not used for recycling are banknotes that are not set to be stored in and fed from the first recycling chamber 15 and the second recycling chamber 16, banknotes that are no longer required to be stored or cannot be stored any more in the first recycling chamber 15 and the second recycling chamber 16 due to a predetermined number of banknotes already stored therein, and the like. When a damaged banknote can be determined, such a banknote can be conveyed to the collection chamber. Banknotes that are not set to be stored in and fed from the first recycling chamber 15 and the second recycling chamber 16 include high denomination banknotes that cannot be used for change, for example. In addition, the collection chamber 7 is used also when collecting all banknotes fed from the first recycling chamber 15 and the second recycling chamber 16, or some banknotes corresponding to specified amounts in response to a collection instruction from the user through an operation terminal. The collection chamber 7 is an example of a storage chamber for storing sheets.

The collection chamber 7 is provided at a bottom portion of the housing 2. Specifically, the collection chamber 7 is disposed on the lower side than all conveyance mechanisms, and can ensure its capacity over the depth direction of the sheet processing apparatus 1 (the housing 2).

The conveyance mechanism 8 connects between the conveyance mechanism 6 and the outlet part 14 through the diversion mechanism 10. The conveyance mechanism 8 conveys the banknote conveyed from the conveyance mechanism 6 to the upper side, or more specifically, to the conveyance mechanism 9 through the diversion mechanism 11. In addition, the conveyance mechanism 8 conveys the banknote conveyed from the conveyance mechanism 6 to the upper side, or more specifically to the conveyance mechanism 13 through the diversion mechanism 11 and the diversion mechanism 12. Alternatively, the conveyance mechanism 8 conveys the banknote conveyed from the conveyance mechanism 6 to the upper side, or more specifically to the outlet part 14 through the diversion mechanism 11 and the diversion mechanism 12. In addition, the conveyance mechanism 8 conveys the banknote conveyed from the conveyance mechanism 9 to the upper side, or more specifically to the outlet part 14 through the diversion mechanism 11 and the diversion mechanism 12. In addition, the conveyance mechanism 8 conveys the banknote conveyed from the conveyance mechanism 13 to the upper side, or more specifically to the outlet part 14 through the diversion mechanism 12.

In the front-rear direction of the apparatus, the conveyance mechanism 8 is provided between the conveyance mechanism 6, and the first recycling chamber 15 and the second recycling chamber 16, i.e., it is disposed on the near side of the housing 2 with respect to the conveyance mechanism 6. The conveyance mechanism 8 is composed of a combination of a plurality of rollers, a plurality of belts, their drive motors, and a plurality of guides. Note that the conveyance mechanism 8 is the second conveyance mechanism. Note that the conveyance mechanism 8 can convey the banknotes to the lower side, i.e., in the direction from the outlet part 14 to the conveyance mechanism 6.

With a diversion mechanism with a diversion at the diversion mechanism 11, the conveyance mechanism 9 conveys the banknote conveyed by the conveyance mechanism 8 to the first recycling chamber 15. The conveyance mechanism 9 with a horizontal diversion from the conveyance mechanism 8 at the diversion mechanism 11 is connected to the first recycling chamber 15, and banknotes are conveyed to the first recycling chamber 15 in the horizontal direction. In addition, the conveyance mechanism 9 conveys to the conveyance mechanism 8 through the diversion mechanism 11 the banknote conveyed from the first recycling chamber 15. The conveyance mechanism 9 is provided between the diversion mechanism 11 and the first recycling chamber 15.

With the diversion mechanism with a diversion at the diversion mechanism 12, the conveyance mechanism 13 conveys to the second recycling chamber 16 the banknote conveyed from the conveyance mechanism 8, and conveys to the conveyance mechanism 8 through the diversion mechanism 12 the banknote conveyed from the second recycling chamber 16. The conveyance mechanism 13 is provided between the diversion mechanism 12 and the second recycling chamber 16 to convey banknotes in the horizontal direction between the diversion mechanism 12 and second recycling chamber.

The diversion mechanisms 10, 11 and 12 is a three-direction diversion mechanism for conveying banknotes by switching the conveyance direction among three conveyance directions. The diversion control of the diversion mechanisms 10, 11 and 12 is performed by switching the diversion in accordance with the detection of passage of banknotes by the sensor. The switch of the diversion is performed through passage detection using a sensor provided in the conveyance mechanism 6 and the recognition result of the recognition unit 5, or passage detection using a sensor provided in the conveyance mechanism 9 or the conveyance mechanism 13 and information stored in the storage medium 19 described later. Examples include a method of switching the diversion in response to light-shielding of the sensor with the end of a banknote, and a method of switching the diversion toward the conveyance destination of the next banknote in response to light transmission at the sensor after passage of the rear end of a preceding banknote.

The outlet part 14 is a part for ejecting banknotes to the outside of the apparatus. The outlet part 14 is provided below the inlet part 3 at the front upper part of the housing 2. The outlet part 14 holds a plurality of banknotes in a stacked state. The user takes out the banknote from the outlet part 14.

The first recycling chamber 15 stores the banknote conveyed from the conveyance mechanism 9. When necessary in the dispensing process, the banknote is conveyed to the outlet part 14 through the conveyance mechanism 9 and the conveyance mechanism 8. The first recycling chamber 15 is provided between the conveyance mechanism 9 and the front surface of the housing 2 in the front-rear direction of the apparatus, and between the collection chamber 7 and the second recycling chamber 16 in the vertical direction. The first recycling chamber 15 is a tape type storage that stores banknotes by winging the banknotes around a drum together with a tape. The first recycling chamber 15 includes a full detection sensor, and detects whether the storage chamber is full with stored banknotes. The full detection sensor is composed of a photo-interrupter, for example. The first recycling chamber 15 is an example of a storage chamber that stores banknotes.

The second recycling chamber 16 stores the banknote conveyed from the conveyance mechanism 13. When necessary in the dispensing process, the banknote is conveyed to the outlet part 14 through the conveyance mechanism 13 and the conveyance mechanism 8. The second recycling chamber 16 is provided between the conveyance mechanism 13 and the front surface of the housing 2 in the front-rear direction of the apparatus, and between the first recycling chamber 15 and the outlet part 14 in the vertical direction. The second recycling chamber 16 is a tape type storage that stores banknotes by winging the banknotes around a drum together with a tape. The second recycling chamber 16 includes a full detection sensor, and detects whether the storage chamber is full with stored banknotes. The full detection sensor is composed of a photo-interrupter, for example. The second recycling chamber 16 is an example of a storage chamber that stores banknotes.

The collection chamber 7 as a storage chamber for storing banknotes, the first recycling chamber 15, and the second recycling chamber 16 make up the storage unit 17 for storing deposited banknotes.

In the present embodiment, the types of banknotes to be stored in the first recycling chamber 15 and the second recycling chamber 16 are predetermined, and they store respective predetermined single denomination banknotes.

Here, the recognition unit 5, and the first recycling chamber 15 and the second recycling chamber 16 are disposed at different positions in the height direction. In this manner, the sheet processing apparatus 1 (the housing 2) can be downsized in the depth direction.

In addition, the recognition unit 5 is disposed at a position higher than the storage unit 17. In this manner, the distance from recognition to storage of a banknote can be increased, and the recognition time can be ensured. To convey banknotes to appropriate conveyance destinations, it is necessary to acquire the recognition result before the diversion toward each conveyance destination (in the present embodiment, before the banknote arrives at the diversion mechanism 10). If the distance from the recognition unit to the diversion is small, the recognition cannot be made in time and appropriate diversion cannot be achieved. Alternatively, it is necessary to adjust the time it takes to acquire the recognition result by stopping the conveyance of the banknote or slowing down the conveyance speed. By ensuring the length of the conveyance mechanism for the movement before acquiring the recognition result, the banknote can be efficiently conveyed to the appropriate conveyance destination without stopping the conveyance or slowing down the speed.

As illustrated in FIG. 3, the control unit 18 controls the operations of the inlet part 3, the conveyance mechanism 4, the recognition unit 5, the conveyance mechanism 6, the collection chamber 7, the conveyance mechanism 8, the conveyance mechanism 9, the diversion mechanism 10, the diversion mechanism 11, the diversion mechanism 12, the conveyance mechanism 13, the outlet part 14, the first recycling chamber 15, the second recycling chamber 16, and the storage medium 19 described above. The control unit 18 is, for example, a CPU. The control unit 18 performs one or more of the control processes discussed in this disclosure. The process data and instructions may be stored in memory like the storage medium 19. These processes and instructions may also be stored on a storage medium disk such as a hard drive (HDD).

The storage medium 19 stores recognition information of the banknote stored in the storage unit 17. The storage medium 19 stores the recognition information of the stored banknote, the stored order, the denomination, the number of sheets, whether or not the state is in the full state, and the like in each of the collection chamber 7, the first recycling chamber 15, and the second recycling chamber 16, for example. Note that the storage medium 19 is a memory of the sheet processing apparatus 1, a memory of a separately connected server, or a memory provided inside the storage unit 17. A plurality of the storage medium 19 may be provided for each of the collection chamber 7, the first recycling chamber 15, and the second recycling chamber 16. In each process described later, the control unit 18 can acquire, from the information held in the storage medium 19, the number of sheets stored in each recycling chamber, the denomination of the sheet stored at the head in each recycling chamber, the full detection state and the like.

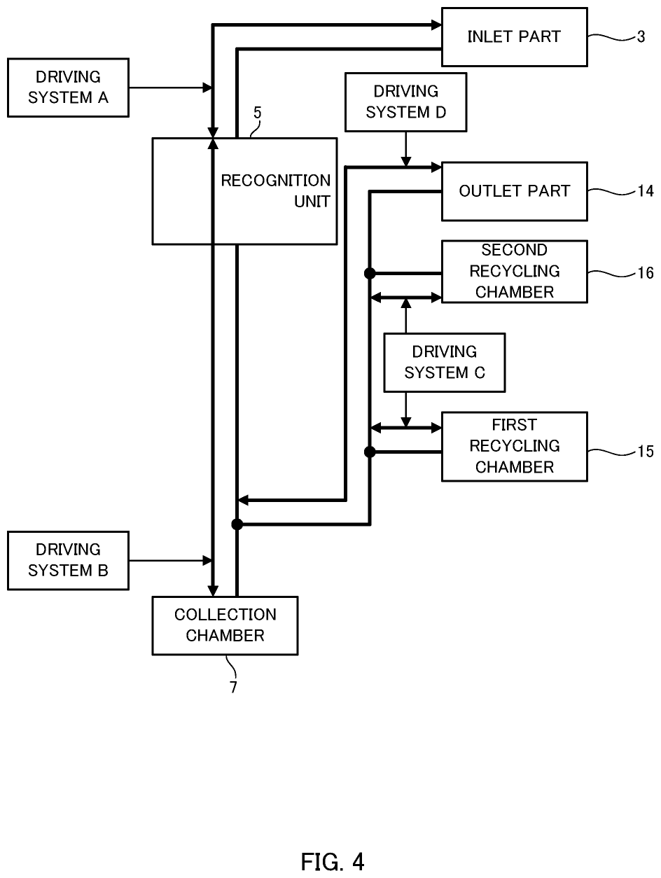

FIG. 4 is a diagram illustrating an example of division of a drive system of the sheet processing apparatus 1. As illustrated in FIG. 4, the sheet processing apparatus 1 includes four drive systems, namely drive systems A, B, C and D. The drive system A drives the conveyance mechanism 4. The drive system B drives the recognition unit 5 and the conveyance mechanism 6. The drive system B may further drive the conveyance mechanism inside the collection chamber 7. The drive system C drives the conveyance mechanism 9 and the conveyance mechanism 13. The drive system D drives the conveyance mechanism 8.

FIG. 4 is an example, and the division of the drive system is not limited to this. Regarding the drive systems of FIG. 4, driving of some systems may be collected, or conversely they may be further divided for driving.

In the entirety of the sheet processing apparatus 1, the banknote conveyance path from the inlet part 3 to the outlet part 14 has a U-shape, and the recognition unit 5 is provided on the inlet part 3 side, and the first recycling chamber 15 and the second recycling chamber 16 as the storage chamber making up the storage unit 17 are provided on the outlet part 14 side.

### Depositing Process

Next, a method of processing the banknote using the sheet processing apparatus 1 according to the first embodiment is described. First, a method of the depositing process of the banknote is described. Note that in this depositing process, the deposited banknotes are stored such that five-dollar banknotes are stored in the first recycling chamber 15 and one-dollar banknotes are stored in the second recycling chamber 16.

First, a banknote is input to the inlet part 3, and then the banknote is conveyed by the conveyance mechanism 4 to the recognition unit 5.

Next, the recognition unit 5 recognizes the banknote type (for example, denomination). On the basis of the recognition result of the recognition unit 5, the control unit 18 controls each unit to convey a one-dollar banknote to the second recycling chamber 16. After the recognition, the one-dollar banknote is conveyed to and stored in the second recycling chamber 16 via the conveyance mechanism 6, the diversion mechanism 10, the diversion mechanism 11, the conveyance mechanism 8, the diversion mechanism 12, and the conveyance mechanism 13, and thus the depositing process is completed.

When the number of the one-dollar banknotes stored in the second recycling chamber 16 is greater than the predetermined number (when it is full), the control unit 18 controls each unit to convey the deposited one-dollar banknote to the collection chamber 7. After the recognition, the one-dollar banknote is conveyed to and stored in the collection chamber 7 via the conveyance mechanism 6 and the diversion mechanism 10, and thus the depositing process is completed. Whether the second recycling chamber 16 is full may be detected by the full detection sensor, or may be determined based on whether the number of stored sheets is greater than a predetermined number. The both determination means may be adopted, or one of the determination means may be adopted for determination.

On the basis of the recognition result of the recognition unit 5, the control unit 18 controls each unit to convey a five-dollar banknote to the first recycling chamber 15. After the recognition, the five-dollar banknote is conveyed to and stored in the first recycling chamber 15 via the conveyance mechanism 6, the diversion mechanism 10, the conveyance mechanism 8, the diversion mechanism 11, and the conveyance mechanism 9, and thus the depositing process is completed.

When the number of the five-dollar banknotes stored in the first recycling chamber 15 is greater than the predetermined number (when it is full), the control unit 18 controls each unit to convey the banknote to the collection chamber 7. The five-dollar banknote is conveyed to and stored in the collection chamber 7 via the conveyance mechanism 6 and the diversion mechanism 10, and thus the depositing process is completed. With the first recycling chamber 15 is full may be detected by the full detection sensor, or may be determined based on whether the number of stored sheets is greater than a predetermined number. The both determination means may be adopted, or one of the determination means may be adopted for determination.

On the other hand, when the banknote is a banknote of other denominations than a one-dollar banknote or a five-dollar banknote, the control unit 18 controls each unit to convey the banknote to the collection chamber 7. After the recognition, the banknote is conveyed to and stored in the collection chamber 7 via the conveyance mechanism 6 and the diversion mechanism 10, and thus the depositing process is completed.

Note that when it is determined to be a counterfeit note, or suspected to be a counterfeit note on the basis of the recognition result of the recognition unit 5, it may be conveyed to the outlet part 14 and ejected out of the apparatus. Alternatively, a rejection chamber may be disposed, and it may be conveyed to and stored in the rejection chamber. When the fitness of the banknote can be determined, deformed banknotes may be ejected out of the apparatus, or stored in the rejection chamber.

### Dispensing Process

Next, a method of a dispensing process of the banknote is described. Note that in this dispensing process, five-dollar banknotes are stored in the first recycling chamber 15, and one-dollar banknotes are stored in the second recycling chamber 16.

When an instruction of dispensing a one-dollar banknote is received, the control unit 18 controls each unit to convey a one-dollar banknote from the second recycling chamber 16 to the outlet part 14. The one-dollar banknote is conveyed to the outlet part 14 via the conveyance mechanism 13, the diversion mechanism 12, and the conveyance mechanism 8 and dispensed. Note that this operation is repeated until the required number of sheets is dispensed on the basis of the dispense instruction.

When an instruction of dispensing a five-dollar banknote is received, the control unit 18 controls each unit to convey a five-dollar banknote from the first recycling chamber 15 to the outlet part 14. The five-dollar banknote is conveyed to the outlet part 14 and dispensed via the conveyance mechanism 9, the diversion mechanism 11, the conveyance mechanism 8, and the diversion mechanism 12. Note that this operation is repeated until the required number of sheets is dispensed on the basis of the dispense instruction.

### Reconciliation Process

Next, a reconciliation process is described. For example, in the case of the occurrence of errors that may affect the storage amount in the recycling chamber such as a jam in the vicinity of the recycling chamber, a jam during deposition, and a jam during dispensing, the control unit 18 sets a reconciliation flag indicating the necessity of reconciliation (the indeterminacy of the storage amount) at the data of the recycling chamber concerned.

When the reconciliation flag is set, the control unit 18 controls each unit to perform a reconciliation process of the recycling chamber concerned. An example case where the reconciliation flag is set for the first recycling chamber 15 is described below.

When the reconciliation flag is set for the first recycling chamber 15, one banknote is fed from the first recycling chamber 15 and conveyed to the recognition unit 5 via the conveyance mechanism 9, the diversion mechanism 11, the conveyance mechanism 6 and the like. The recognition unit 5 recognizes the conveyed banknote. The reconciliation is implemented by confirming whether the information stored in the storage medium 19 and the information of the recognized banknote coincide with each other. When the information stored in the storage medium 19 and the information of the recognized banknote coincide with each other, the control unit 18 determines that the storage amount of the banknotes stored in the first recycling chamber 15 coincides with the data and is determined, and removes the reconciliation flag.

At this time, to acquire the recognition result of the recognition unit 5, it is necessary to continuously drive the recognition unit 5. In the present embodiment, as illustrated in FIG. 4, the drive system of the conveyance mechanism 6+the recognition unit 5, and the drive system of the conveyance mechanism 4 are different from each other. When a banknote is passed through the recognition unit 5 and conveyed to the conveyance mechanism 4, the drive system A stops its driving. On the other hand, the drive system B of the conveyance mechanism 6+the recognition unit 5 is continuously driven to acquire the recognition result.

When the reconciliation is completed on the basis of the recognition result, the drive of the conveyance mechanism 4 is inverted and restarted, and the drive of the conveyance mechanism 6 is inverted to convey the recognized banknote to the collection chamber 7. Alternatively, when the information stored in the storage medium 19 and the recognized information coincide with each other as a result of the recognition, it may be returned to the first recycling chamber 15 where it has been originally stored.

When the information stored in the storage medium 19 and the recognized information do not coincide with each other as a result of the recognition, the banknote may be conveyed to the outlet part 14 to eject it to the outside of the apparatus, and then a banknote is fed anew from the first recycling chamber 15 to perform recognition and reconciliation on it. Alternatively, it is possible to adopt a configuration in which another storage unit such as a rejection chamber is provided, and when the information stored in the storage medium 19 and the recognized information do not coincide with each other as a result of the recognition, the recognized banknote is conveyed to the rejection chamber.

In this manner, since the driving of the conveyance mechanism 4 can be stopped while the banknote conveyed by the conveyance mechanism 6 is recognized by the recognition unit 5, it is not necessary to ensure the conveyance path corresponding to the conveyance distance for recognition, which can reduce the apparatus size.

Note that it is possible to a circulating conveyance path connecting from the conveyance mechanism 4 to the conveyance mechanism 8 may be formed instead of dividing the driving of the recognition unit 5 and the conveyance mechanism 4. In this case, the banknote can be conveyed in a circulating manner without stopping the driving, and thus the banknote is prevented from being fed from the inlet part 3 without the necessity to ensure the length of the conveyance distance of the banknote for recognition for the conveyance mechanism 4. In addition, after the recognition result is acquired, it may be conveyed to the collection chamber 7 as it is without inverting the driving.

When the reconciliation flag is set for the second recycling chamber 16, the reconciliation process can be executed by the same method.

In this manner, with the sheet processing apparatus according to the first embodiment, the size of the sheet processing apparatus can be reduced, and a conveyance in accordance with the recognition result can be achieved through a simple control.

### Second Embodiment

Next, a sheet processing apparatus of a second embodiment of the present disclosure is described. Note that in the second embodiment described below, the same components as those of the first embodiment are denoted with the same reference numerals in the drawing and the description thereof will be omitted. In the second embodiment, mixed denominations are set to be stored in the first recycling chamber.

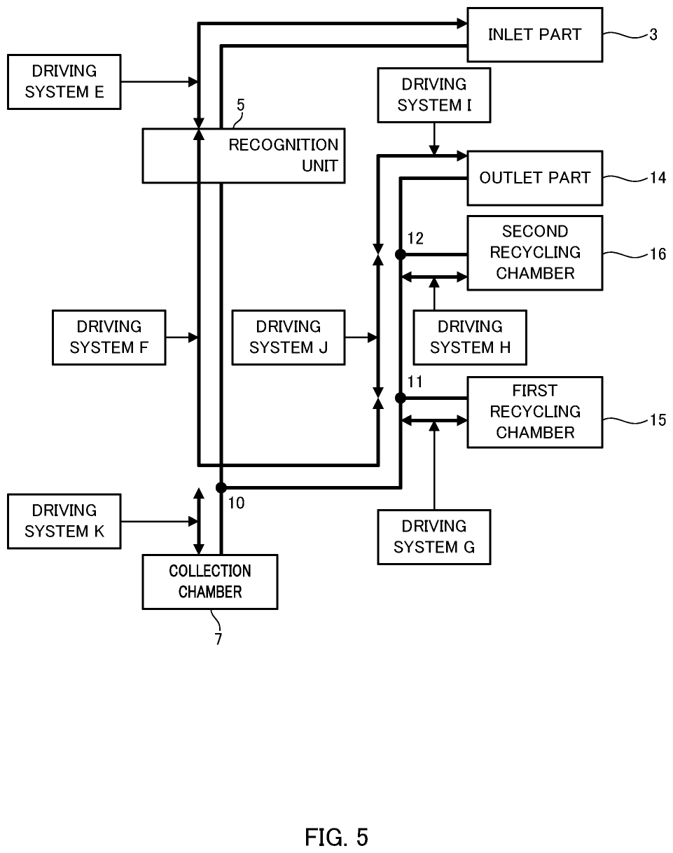

A second embodiment is described below with reference to the attached drawings. FIG. 5 is a diagram illustrating an example of division of a drive system of a sheet processing apparatus according to the second embodiment. The internal configuration of the sheet processing apparatus and the functional configuration of the sheet processing apparatus are the same as those of the first embodiment, and therefore the description thereof will be omitted.

As illustrated in FIG. 5, the sheet processing apparatus 1 includes seven drive systems, namely drive systems E, F, G, H, I, J and K. The drive system E drives the conveyance mechanism 4. The drive system F drives the section between the diversion mechanism 10 and the diversion mechanism 11 in the recognition unit 5, the conveyance mechanism 6, and the conveyance mechanism 8. The drive system G drives the conveyance mechanism 9. The drive system H drives the conveyance mechanism 13. The drive system I drives the section from the diversion mechanism 12 to the outlet part 14 in the conveyance mechanism 8. The drive system J drives the section between the diversion mechanism 11 and the diversion mechanism 12 in the conveyance mechanism 8. The drive system K drives the conveyance mechanism from the diversion mechanism 10 to the collection chamber 7. The drive system K may further drive the driving mechanism inside the collection chamber 7.

FIG. 5 is an example, and the division of the drive system is not limited to this. For example, in the second embodiment, the drive systems I and J, and the drive systems G and H may be each a single drive system.

The sheet processing apparatus 1 performs a depositing process and a dispensing process of sheets such as banknotes. The sheet processing apparatus 1 can perform the depositing process of banknotes of several types while it can perform the dispensing process of banknotes of three types (three-denomination mode). In this example, the banknotes to be dispensed are three types of banknotes, namely one-dollar banknotes, five-dollar banknotes, and ten-dollar banknotes.

In the second embodiment, the first recycling chamber 15 stores banknotes of two types conveyed from the conveyance mechanism 9. When necessary in the dispensing process, the banknotes of two types are conveyed to the outlet part 14 through the conveyance mechanism 9 and the conveyance mechanism 8. Specifically, the first recycling chamber 15 is configured to store mixed denominations. In this example, five-dollar banknotes and ten-dollar banknotes are stored in the first recycling chamber 15.

The second recycling chamber 16 stores the banknote conveyed from the conveyance mechanism 13. When necessary in the dispensing process, the banknotes are conveyed to the outlet part 14 via the conveyance mechanism 13 and the conveyance mechanism 8. In this example, the second recycling chamber 16 stores one-dollar banknotes.

In the present embodiment, the first recycling chamber 15 is set to the mixed-denomination mode for storing mixed banknotes of two types, while the second recycling chamber 16 is set to the single-denomination mode for storing a banknote of one type.

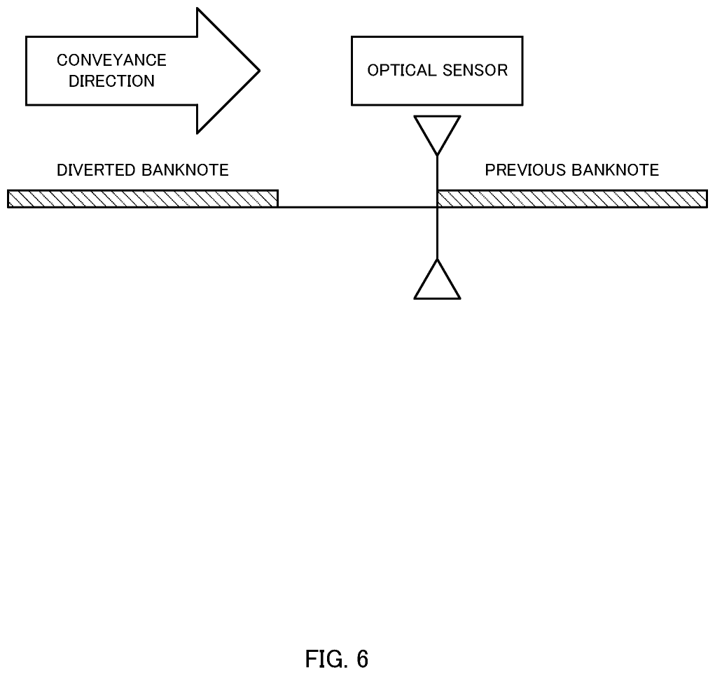

Here, with reference to FIG. 6, a method of switching the diversion in response to light transmission of the rear end of a preceding banknote at a diversion mechanism is described. FIG. 6 is a diagram for describing a timing of switching of a diversion mechanism. This method is a method of switching the diversion by determining the diversion direction of the banknote conveyed next after the rear end of a banknote conveyed ahead has passed through a photosensor. In the case of the determination of the light-shielding with the end of the banknote being conveyed, the conveyance distance from the sensor to the completion of the diversion operation is required. On the other hand, in the case of the determination of the light transmission of the rear end of the preceding banknote, the conveyance distance from the sensor to the completion of the diversion operation can be reduced because the space between the preceding banknote wound by the recycling chamber and the banknote of the diversion target is used. Since the diversion is switched in accordance with the conveyance destination of the next banknote in response to passage of the rear end of the preceding banknote, switching of the diversion can be started before the light-shielding of the sensor with the end of the banknote, and thus the conveyance distance required for switching the diversion mechanism can be reduced.

For example, in the case where banknotes of mixed denominations are stored in the first recycling chamber 15, the sheet processing apparatus 1 has to distribute the banknotes to the direction of the collection chamber 7 or the direction of the outlet part 14 at the diversion mechanism 11 in accordance with the denominations when feeding and conveying the banknotes from the first recycling chamber 15. To reduce the distance between the diversion mechanism 11 and the first recycling chamber 15, the diversion control of the diversion mechanism 11 is performed by a method of switching the diversion in response to detection of the rear end of the preceding banknote with the sensor provided at the first recycling chamber 15. The operation of the switching of the diverter is started after a predetermined time after detection of the rear end of the preceding banknote. The predetermined time is set in advance to an estimated time it takes for the preceding banknote to reach the outside of the operation range of the diverter after the detection of the rear end of the preceding banknote. Note that the sensor for detecting the rear end of the preceding banknote may be provided at the conveyance mechanism 9.

Note that the denominations and serial numbers of the banknotes stored in the first recycling chamber 15 and the second recycling chamber 16 are recognized by the recognition unit 5, and their details and orders are stored in the storage medium 19. Thus, the diversion operation for the banknote conveyed first can be completed before the conveyance is actually started. The diversion control described with reference to FIG. 6 is used for switching the diversion in the conveyance of the stored second and subsequent banknotes.

### Depositing Process

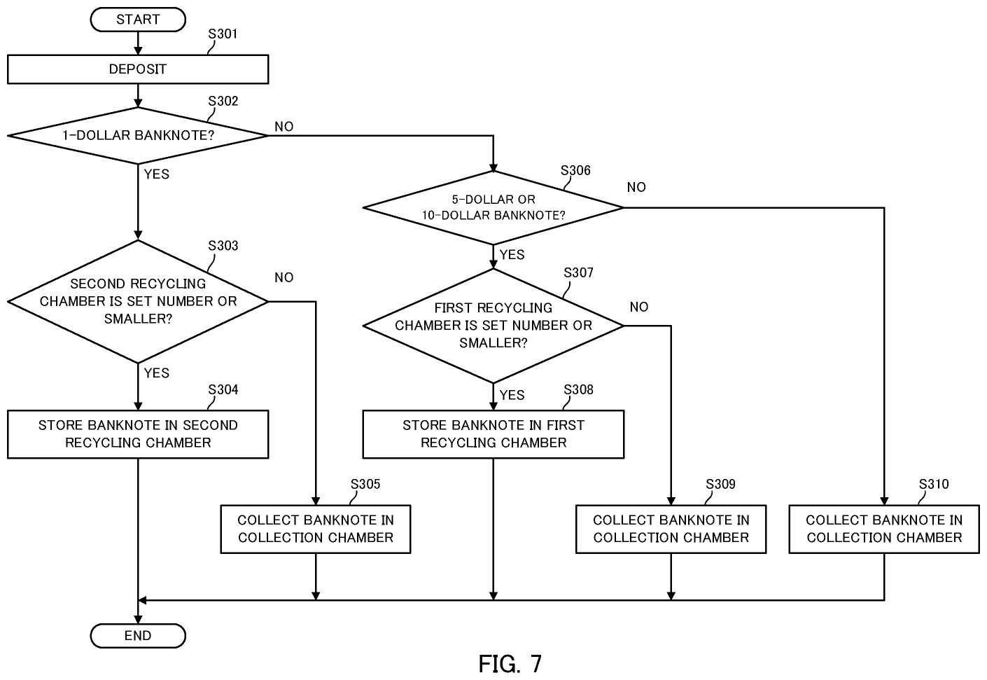

Next, a method of processing the banknote using the sheet processing apparatus 1 according to the second embodiment is described. First, a method of the depositing process of the banknote is described. FIG. 7 is a flowchart illustrating a method of depositing a banknote using the sheet processing apparatus 1 according to the second embodiment. Note that in this depositing process, the first recycling chamber 15 stores five-dollar banknotes and ten-dollar banknotes, and the second recycling chamber 16 stores one-dollar banknotes. Note that when there is a damaged banknote, a counterfeit banknote or a banknote suspected to be a counterfeit banknote, such a banknote may be conveyed to the outlet part 14 to eject it out of the apparatus.

First, a banknote is deposited to the inlet part 3, and then the banknote is conveyed by the conveyance mechanism 4 to the recognition unit 5 (step S301).

Next, the recognition unit 5 recognizes the banknote type. The recognition result of the recognition unit 5 is a one-dollar banknote (step S302, Yes), the control unit 18 confirms whether the number of the one-dollar banknotes stored in the second recycling chamber 16 is not greater than the predetermined number (step S303).

The number of the one-dollar banknotes stored in the second recycling chamber 16 is not greater than the predetermined number (step S303, Yes), the control unit 18 controls each unit to convey the deposited one-dollar banknote to the second recycling chamber 16. After the recognition, the one-dollar banknote is conveyed to and stored in the second recycling chamber 16 via the conveyance mechanism 6, the diversion mechanism 10, the diversion mechanism 11, the conveyance mechanism 8, the diversion mechanism 12, and the conveyance mechanism 13 (step S304), and thus the depositing process is completed.

When the number of the one-dollar banknotes stored in the second recycling chamber 16 is greater than the predetermined number (when it is full) (step S303, No), the control unit 18 controls each unit to convey the deposited one-dollar banknote to the collection chamber 7. After the recognition, the one-dollar banknote is conveyed to and stored in the collection chamber 7 via the conveyance mechanism 6 and the diversion mechanism 10 (step S305), and thus the depositing process is completed.

On the other hand, when the recognition result of the recognition unit 5 is a five-dollar banknote or a ten-dollar banknote (step S306, Yes), the control unit 18 confirms whether the number of the banknotes stored in the first recycling chamber 15 is not greater than the predetermined number (step S307).

When the number of the banknotes stored in the first recycling chamber 15 is not greater than the predetermined number (step S307, Yes), the control unit 18 controls each unit to convey the deposited five-dollar banknote or ten-dollar banknote to the first recycling chamber 15. After the recognition, the five-dollar banknote or ten-dollar banknote is conveyed to and stored in the first recycling chamber 15 via the conveyance mechanism 6, the diversion mechanism 10, the diversion mechanism 11, and the conveyance mechanism 9 (step S308), and thus the depositing process is completed.

When the number of the banknotes stored in the first recycling chamber 15 is greater than the predetermined number (when it is full) (step S307, No), the control unit 18 controls each unit to convey the deposited banknote to the collection chamber 7. After the recognition, the five-dollar banknote or ten-dollar banknote is conveyed to and stored in the collection chamber 7 via the conveyance mechanism 6 and the diversion mechanism 10 (step S309), and thus the depositing process is completed.

On the other hand, when the recognition result of the recognition unit 5 is not a one-dollar banknote, a five-dollar banknote, or a ten-dollar banknote (step S306, No), the control unit 18 controls each unit to convey the deposited banknote to the collection chamber 7. The deposited banknote is conveyed to and stored in the collection chamber 7 via the conveyance mechanism 8, and the diversion mechanism 10 (step S310), and thus the depositing process is completed.

After the above-described depositing process, the first recycling chamber 15 stores five-dollar banknotes and ten-dollar banknotes in a mixed state, and the second recycling chamber 16 stores one-dollar banknotes.

Note that when a ten-dollar banknote is deposited, it is possible to confirm the number of ten-dollar banknotes stored on the head side than the five-dollar banknote closest to the head in the first recycling chamber 15. In the case where a predetermined number or more of ten-dollar banknotes have been already stored on the head side than the five-dollar banknote, the deposited ten-dollar banknote may be conveyed to the collection chamber 7 without being conveyed to the first recycling chamber 15. In this manner, it is possible to suppress a situation where when dispensing a five-dollar banknote, the dispensing time is increased due to ten-dollar banknotes unnecessary for the dispensing conveyed to the collection chamber 7.

In addition, in this flowchart, whether each recycling chamber is not in a full state is determined based on whether the number of stored sheets is not greater than the predetermined number, but it may be determined based on a detection state of the full detection sensor provided in each recycling chamber. In addition, both the determination based on the number of sheets and the determination based on the full detection sensor may be adopted.

### Dispensing Process

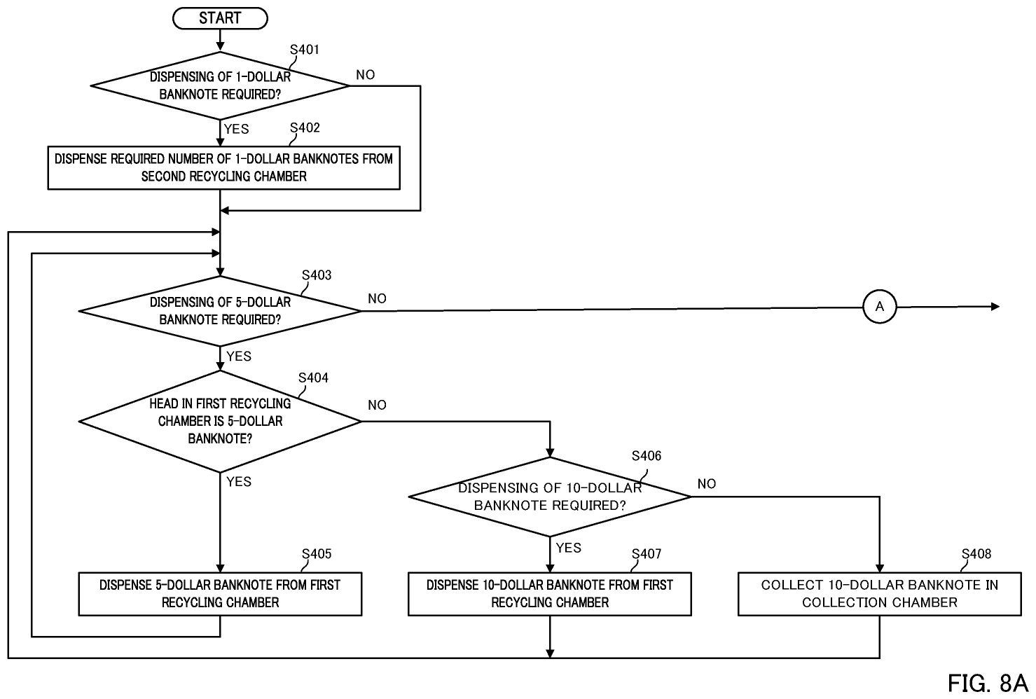

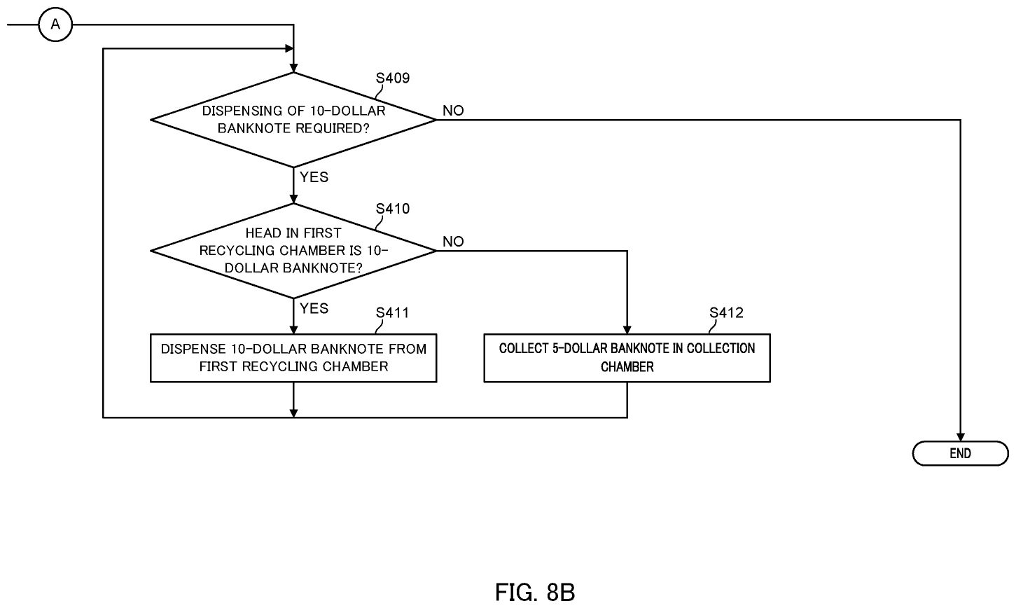

Next, a method of a dispensing process of the banknote is described. FIGS. 8A and 8B are flowcharts illustrating a method of dispensing a banknote using the sheet processing apparatus 1 according to the second embodiment. Note that in this dispensing process, the first recycling chamber 15 stores five-dollar banknotes and ten-dollar banknotes, and the second recycling chamber 16 stores one-dollar banknotes. Note that in this flowchart, after a banknote of the denomination as the dispensing target included in a request of the dispensing process is dispensed, it is excluded from the dispensing target in the next step.

First, when receiving a request of the dispensing process, the control unit 18 determines whether it is necessary to dispense a one-dollar banknote (whether it is the dispensing target) (step S401).

When it is necessary to dispense a one-dollar banknote (step S401, Yes), the control unit 18 controls each unit to convey a required number of one-dollar banknotes from the second recycling chamber 16 to the outlet part 14. The one-dollar banknote is conveyed to the outlet part 14 via the conveyance mechanism 13, the diversion mechanism 12, and the conveyance mechanism 8 and dispensed (step S402).

When the operation of step 402 is completed, or when it is not necessary to dispense a one-dollar banknote (step S401, No), the control unit 18 determines whether it is necessary to dispense a five-dollar banknote (whether it is the dispensing target) (step S403).

When it is necessary to dispense a five-dollar banknote (step S403, Yes), the control unit 18 confirms whether a five-dollar banknote is present at the head in the first recycling chamber 15 (step S404).

When a five-dollar banknote is present at the head in the first recycling chamber 15 (step S404, Yes), the control unit 18 controls each unit to convey a five-dollar banknote from the first recycling chamber 15 to the outlet part 14. The five-dollar banknote is conveyed to the outlet part 14 via the conveyance mechanism 9, the diversion mechanism 11, and the conveyance mechanism 8 and dispensed (step S405). The process is returned to step S403.

When the five-dollar banknote is not present at the head in the first recycling chamber 15, that is, when there is a ten-dollar banknote (step S404, No), the control unit 18 determines whether it is necessary to dispense a ten-dollar banknote (whether it is the dispensing target) (step S406).

When it is necessary to dispense a ten-dollar banknote (step S406, Yes), the control unit 18 controls each unit to convey a ten-dollar banknote from the first recycling chamber 15 to the outlet part 14. The ten-dollar banknote is conveyed to the outlet part 14 via the conveyance mechanism 9, the diversion mechanism 11, and the conveyance mechanism 8 and dispensed (step S407). The process is returned to step S403.

When it is not necessary to dispense a ten-dollar banknote (step S406, No), the control unit 18 controls each unit to convey a ten-dollar banknote to the collection chamber 7. The ten-dollar banknote is conveyed to and stored in the collection chamber 7 via the conveyance mechanism 9, the diversion mechanism 11, the conveyance mechanism 8, and the conveyance mechanism 6 (step S408). The process is returned to step S403.

Steps 403 to 408 are repeated until the required number of five-dollar banknotes is dispensed.

When it is not necessary to dispense a five-dollar banknote (step S403, No), the control unit 18 determines whether it is necessary to dispense a ten-dollar banknote (whether it is the dispensing target) (step S409).

When it is necessary to dispense a ten-dollar banknote (step S409, Yes), the control unit 18 confirms whether a ten-dollar banknote is present at the head in the first recycling chamber 15 (step S410).

When a ten-dollar banknote is present at the head in the first recycling chamber 15 (step S410, Yes), the control unit 18 controls each unit to convey a ten-dollar banknote from the first recycling chamber 15 to the outlet part 14. The ten-dollar banknote is conveyed to the outlet part 14 via the conveyance mechanism 9, the diversion mechanism 11, and the conveyance mechanism 8 and dispensed (step S411). The process is returned to step S409.

When the ten-dollar banknote is not present at the head in the first recycling chamber 15, that is, when there is a five-dollar banknote (step S410, No), the control unit 18 controls each unit to convey a five-dollar banknote to the collection chamber 7. The five-dollar banknote is conveyed to and stored in the collection chamber 7 via the conveyance mechanism 9, the diversion mechanism 11, the conveyance mechanism 8, and the conveyance mechanism 6 (step S412). The process is returned to step S409.

Steps 409 to 412 are repeated until a required number of ten-dollar banknotes is dispensed.

When it is not necessary to dispense a ten-dollar banknote (step S409, No), all banknotes requested to be dispensed have been dispensed, and the dispensing process is completed.

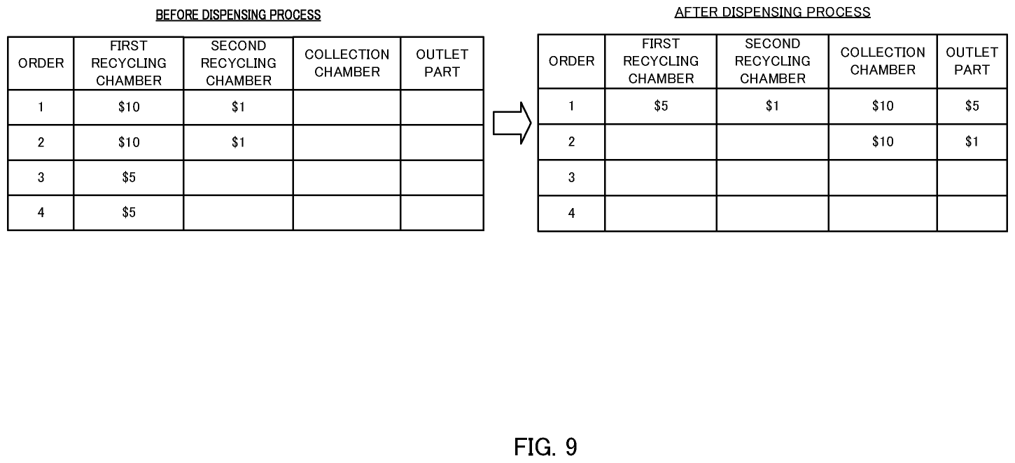

FIG. 9 is a diagram illustrating an example case where how a banknote is conveyed in a dispensing process. In this example, a total of 6 dollars is dispensed. One one-dollar banknote is dispensed from the second recycling chamber 16, and one five-dollar banknote is dispensed from the first recycling chamber 15. The two ten-dollar banknotes located at the head in the first recycling chamber 15 are not required to be dispensed (non-dispensing target), and therefore collected in the collection chamber 7.

In this manner, with the sheet processing apparatus according to the second embodiment, one of two recycling chambers is set such that a plurality of mixed denominations can be stored and fed, and thus depositing and dispensing can be achieved with a smaller number of recycling chambers than the number of denominations to be recycled. In this manner, the size of the sheet processing apparatus can be reduced. Further, with the mixture of two recycling chambers, multiple movements in the storage unit can be prevented, and thus the occurrence of jam due to dispensing of damaged sheets can be reduced.

### Third Embodiment

Next, a sheet processing apparatus of a third embodiment of the present disclosure is described. Note that in the third embodiment described below, the same components as those of the first and second embodiments are denoted with the same reference numerals in the drawing and the description thereof will be omitted. In the third embodiment, mixed denominations are set to be stored in the first recycling chamber and the second recycling chamber.

The third embodiment is described below with reference to the attached drawings. The internal configuration of the sheet processing apparatus and the functional configuration of the sheet processing apparatus are the same as those of the first and second embodiments, and therefore the description thereof will be omitted.

The division configuration of the drive system of the sheet processing apparatus is the same as that of the second embodiment, and therefore the description thereof will be omitted. Note that regarding the division configuration of the drive system in the present embodiment, the drive systems I and J in FIG. 5 may be a single drive system.

In the present embodiment, the first recycling chamber 15 stores banknotes of two types conveyed from the conveyance mechanism 9. In this example, the first recycling chamber 15 stores five-dollar banknotes and ten-dollar banknotes.

The second recycling chamber 16 stores banknotes of two types conveyed from the conveyance mechanism 13. In this example, the second recycling chamber 16 normally stores one-dollar banknotes, but may also store ten-dollar banknotes in a mixed state.

In the present embodiment, the first recycling chamber 15 and the second recycling chamber 16 are set to the mixed-denomination mode for storing mixed banknotes of two types. It should be noted that the deposited ten-dollar banknote is set to be preferentially stored in the first recycling chamber 15.

Next, a method of processing the banknote using the sheet processing apparatus 1 according to the third embodiment is described. Note that a method of the depositing process of the banknote is the same as the method of the depositing process described in the second embodiment, and therefore the description thereof is omitted.

### Dispensing Process

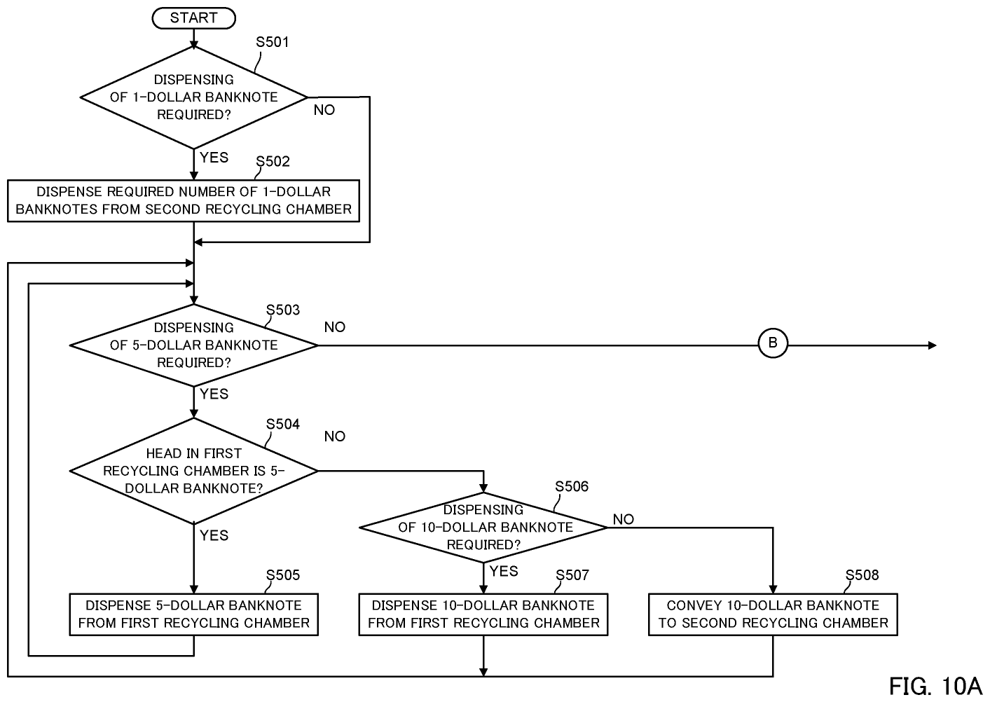

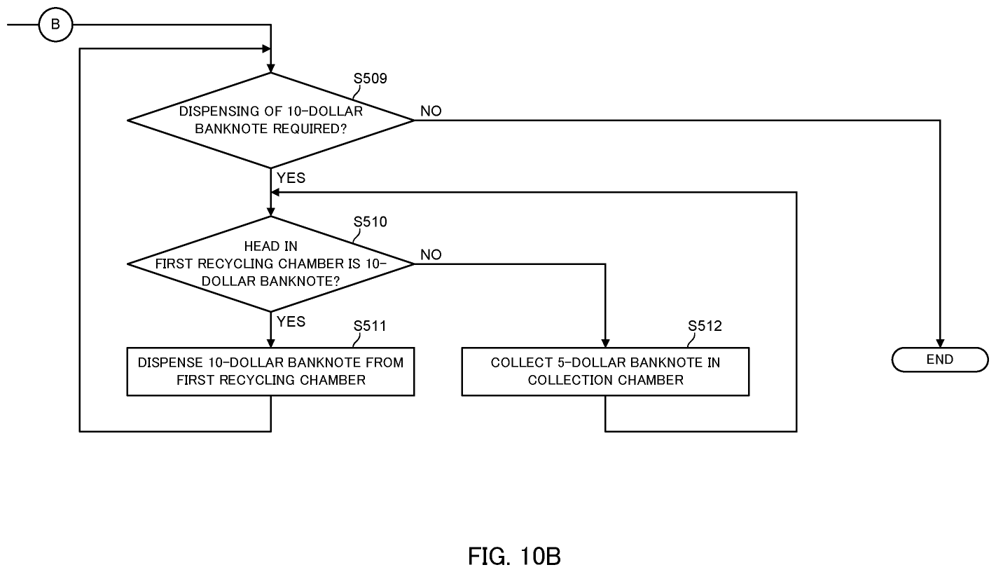

A method of a dispensing process of the banknote is described. FIGS. 10A and 10B are flowcharts illustrating a method of dispensing a banknote using the sheet processing apparatus 1 according to the third embodiment. Note that in this dispensing process, the first recycling chamber 15 stores five-dollar banknotes and ten-dollar banknotes, and the second recycling chamber 16 stores one-dollar banknotes. Note that in this flowchart, after a banknote of the denomination as the dispensing target included in a request of the dispensing process is dispensed, it is excluded from the dispensing target in the next step.

First, when receiving a request of the dispensing process, the control unit 18 determines whether it is necessary to dispense a one-dollar banknote (whether it is the dispensing target) (step S501).

When it is necessary to dispense a one-dollar banknote (step S501, Yes), the control unit 18 controls each unit to convey a required number of one-dollar banknotes from the second recycling chamber 16 to the outlet part 14. The one-dollar banknote is conveyed to the outlet part 14 via the conveyance mechanism 13, the diversion mechanism 12, and the conveyance mechanism 8 and dispensed (step S502).

When the operation of step 502 is completed, or when it is not necessary to dispense a one-dollar banknote (step S501, No), the control unit 18 determines whether it is necessary to dispense a five-dollar banknote (whether it is the dispensing target) (step S503).

When it is necessary to dispense a five-dollar banknote (step S503, Yes), the control unit 18 confirms whether a five-dollar banknote is present at the head in the first recycling chamber 15 (step S504).

When a five-dollar banknote is present at the head in the first recycling chamber 15 (step S504, Yes), the control unit 18 controls each unit to convey a five-dollar banknote from the first recycling chamber 15 to the outlet part 14. The five-dollar banknote is conveyed to the outlet part 14 via the conveyance mechanism 9, the diversion mechanism 11, and the conveyance mechanism 8 and dispensed (step S505). The process is returned to step S503.

When the five-dollar banknote is not present at the head in the first recycling chamber 15, that is, when there is a ten-dollar banknote (step S504, No), the control unit 18 determines whether it is necessary to dispense a ten-dollar banknote (whether it is the dispensing target) (step S506).

When it is necessary to dispense a ten-dollar banknote (step S506, Yes), the control unit 18 controls each unit to convey a ten-dollar banknote from the first recycling chamber 15 to the outlet part 14. The ten-dollar banknote is conveyed to the outlet part 14 via the conveyance mechanism 9, the diversion mechanism 11, and the conveyance mechanism 8 and dispensed (step S507). The process is returned to step S503.

When it is not necessary dispense the ten-dollar banknote (non-dispensing target) (step S506, No), the control unit 18 controls each unit to convey the ten-dollar banknote to the second recycling chamber 16. The ten-dollar banknote is conveyed to and stored in the second recycling chamber 16 via the conveyance mechanism 9, the diversion mechanism 11, the conveyance mechanism 8, the diversion mechanism 12, and the conveyance mechanism 13 (step S508). The process is returned to step S503. Note that in this step, when the second recycling chamber 16 is in a full state, the ten-dollar banknote is conveyed to the collection chamber 7. The state where the second recycling chamber 16 is not in a full state is determined based on whether the number of stored sheets is not greater than the predetermined number. Alternatively, it is determined based on the detection state of the full detection sensor. It may be determined by both the determination based on the number of sheets and the determination based on the full detection sensor.

Steps 503 to 508 are repeated until the required number of five-dollar banknotes is dispensed.

When it is not necessary to dispense a five-dollar banknote (step S503, No), the control unit 18 determines whether it is necessary to dispense a ten-dollar banknote (step S509).

When it is necessary to dispense a ten-dollar banknote (step S509, Yes), the control unit 18 confirms whether a ten-dollar banknote is present at the head in the first recycling chamber 15 (step S510).

When a ten-dollar banknote is present at the head in the first recycling chamber 15 (step S510, Yes), the control unit 18 controls each unit to convey a ten-dollar banknote from the first recycling chamber 15 to the outlet part 14. The ten-dollar banknote is conveyed to the outlet part 14 via the conveyance mechanism 9, the diversion mechanism 11, and the conveyance mechanism 8 and dispensed (step S511). The process is returned to step S509.

When the ten-dollar banknote is not present at the head in the first recycling chamber 15, that is, when there is a five-dollar banknote (step S510, No), the control unit 18 controls each unit to convey a five-dollar banknote from the first recycling chamber 15 to the collection chamber 7. The five-dollar banknote is conveyed to and stored in the collection chamber 7 via the conveyance mechanism 9, the diversion mechanism 11, and the conveyance mechanism 6 (step S512). The process is returned to step S510.

Finally, when it is not necessary to dispense a ten-dollar banknote (step S509, No), all banknotes requested to be dispensed have been dispensed, and the dispensing process is completed.

After the dispensing process, the first recycling chamber 15 stores five-dollar banknotes and ten-dollar banknotes in a mixed state, and the second recycling chamber 16 stores one-dollar banknotes and in some cases stores one-dollar banknotes and ten-dollar banknotes in a mixed state.

Note that in the case where a ten-dollar banknote is temporarily stored in the second recycling chamber 16 after the completion of the dispensing process, it is conveyed to the first recycling chamber 15 before the start of the next process as a post-processing. As a result, as in a post depositing process state, the first recycling chamber 15 stores five-dollar banknotes and ten-dollar banknotes in a mixed state, and the second recycling chamber 16 stores one-dollar banknotes.

Note that in the above-described flowchart, when the number of ten-dollar banknotes stored on the head side in the second recycling chamber 16 is greater than a predetermined number, the ten-dollar banknotes in excess of the predetermined number may be conveyed to the collection chamber 7, not to the first recycling chamber 15.

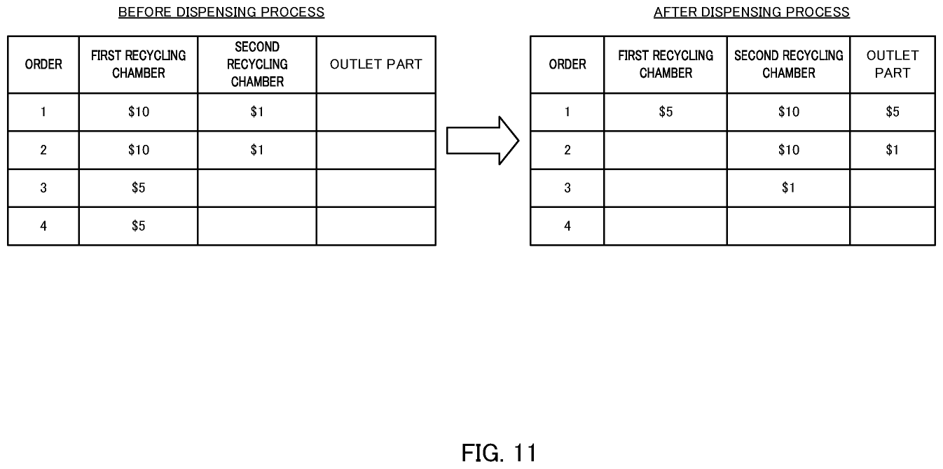

FIG. 11 is a diagram illustrating an example case where how a banknote is conveyed in a dispensing process. In this example, a total of 6 dollars is dispensed. One one-dollar banknote is dispensed from the second recycling chamber 16, and one five-dollar banknote is dispensed from the first recycling chamber 15. Two ten-dollar banknotes located at the head in the first recycling chamber 15 are conveyed to the second recycling chamber 16 after one one-dollar banknote is dispensed from the second recycling chamber 16. As described above, the two ten-dollar banknotes conveyed to the second recycling chamber 16 are conveyed to the first recycling chamber 15 before the start of the next process in the post-processing after the dispensing process.

Note that at step S512, the five-dollar banknote may be conveyed to and stored in the second recycling chamber 16 instead of storing it in the collection chamber 7. In this case, as with the above-described ten-dollar banknote, it may be conveyed to the first recycling chamber 15 before the start of the next process in the post-processing after the dispensing process.

In this manner, in the sheet processing apparatus according to the third embodiment, with the two recycling chambers both set to the mixed-denomination mode, the banknote of the non-dispensing target fed from one recycling chamber can be conveyed to the other recycling chamber, not the collection chamber. In this manner, the number of non-dispensable banknotes can be reduced, and the frequency of collection of banknotes to the outside of the sheet processing apparatus and replenishment of banknotes to the sheet processing apparatus can be reduced. Further, in-store or CIT management costs can be reduced, and the risk of occurrence of non-usable time (out of service) of the sheet processing apparatus can be reduced.

### Fourth Embodiment

Next, a sheet processing apparatus of a fourth embodiment of the present disclosure is described. Note that the configuration of the fourth embodiment described below is the same as that of the third embodiment, and therefore description of the detailed configuration will be omitted. The fourth embodiment is different from the third embodiment in the method of the depositing process and the dispensing process of the control unit.

Note that in the division configuration of the drive system of the present embodiment, the drive systems F and G and the drive systems I and J may be both a single drive system in FIG. 5. Alternatively, the drive systems G and J and the drive systems H and I may be both a single drive system.

In addition, in the case where the second recycling chamber 16 stores recycling banknotes of mixed denominations, the diversion control is performed also at the diversion mechanism 12 by a method of switching the diversion to the next banknote conveyance direction in response to the light-shielding of the sensor with the rear end of the preceding banknote illustrated in FIG. 6.

In the third embodiment, in the dispensing process, the ten-dollar banknotes stored in the second recycling chamber 16 are conveyed to the first recycling chamber 15 before the start of the next process. On the other hand, the fourth embodiment describes an example in which the depositing process and the dispensing process are performed in the state where the ten-dollar banknotes are stored in the second recycling chamber 16.

### Depositing Process

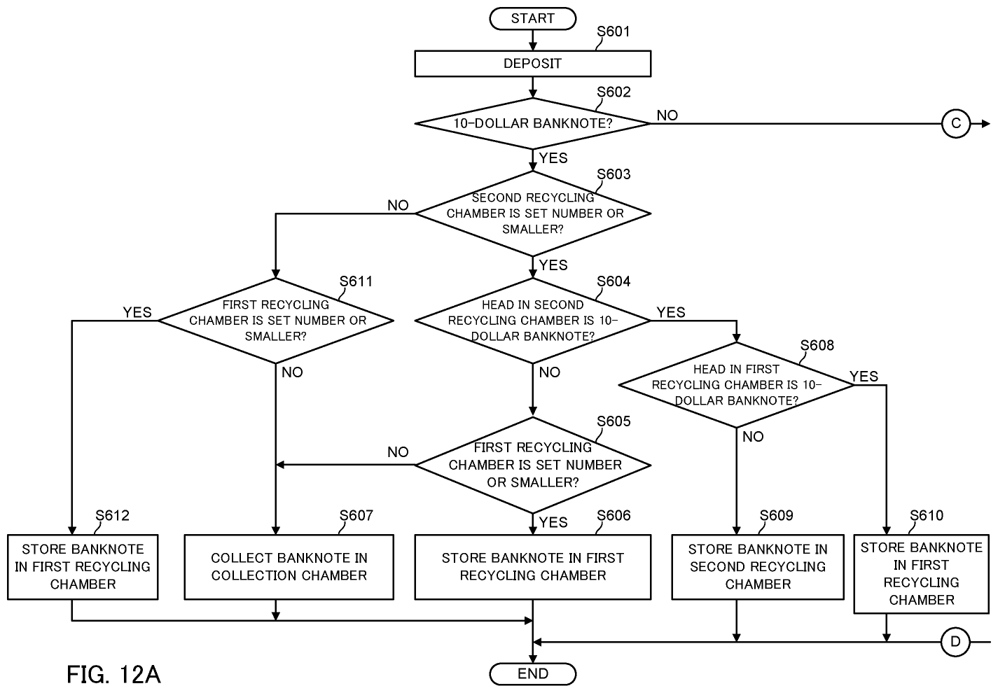

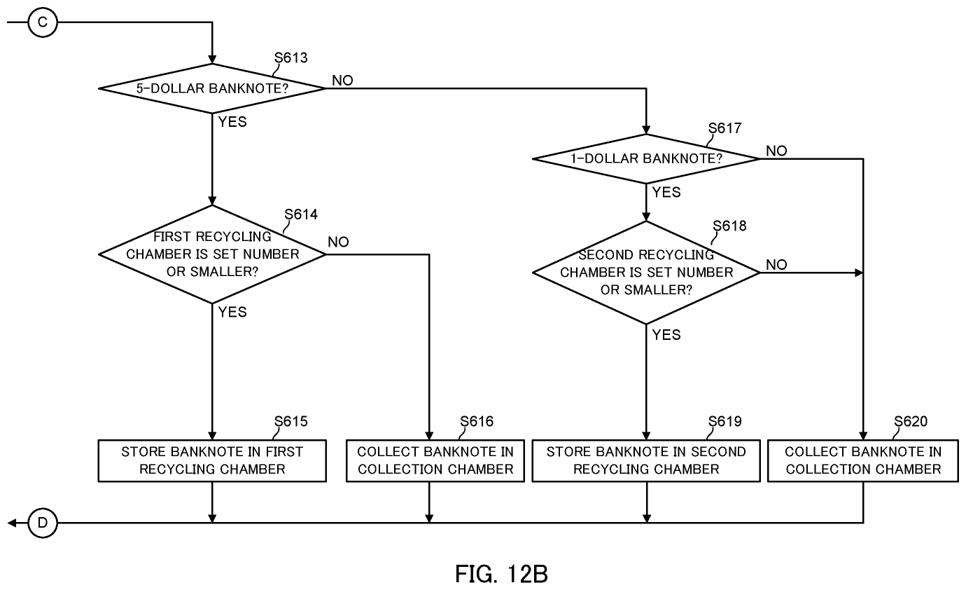

A method of processing the banknote using the sheet processing apparatus 1 according to the fourth embodiment is described below. First, a method of the depositing process of the banknote is described. FIGS. 12A and 12B are flowcharts illustrating a method of depositing a banknote using the sheet processing apparatus 1 according to the fourth embodiment. Note that in this depositing process, the first recycling chamber 15 stores five-dollar banknotes and ten-dollar banknotes, and the second recycling chamber 16 stores one-dollar banknotes and ten-dollar banknotes. A damaged banknote may be stored in the collection chamber 7, and a counterfeit banknote or a banknote suspected to be a counterfeit banknote may be ejected out of the apparatus from the outlet part 14. In addition, in the present embodiment, ten-dollar banknotes are set to be preferentially conveyed to the first recycling chamber 15.

First, a banknote is deposited to the inlet part 3, and then the banknote is conveyed by the conveyance mechanism 4 to the recognition unit 5 (step S601).

Next, when the recognition unit 5 recognizes the banknote type and the banknote is a ten-dollar banknote (step S602, Yes), the control unit 18 confirms whether the number of the banknotes stored in the second recycling chamber 16 is not greater than the predetermined number (step S603).

When the number of the banknotes stored in the second recycling chamber 16 is not greater than the predetermined number (step S603, Yes), the control unit 18 confirms whether a ten-dollar banknote is present at the head in the second recycling chamber 16 (step S604).

When the ten-dollar banknote is not present at the head in the second recycling chamber 16 (step S604, No), the control unit 18 confirms whether the number of the banknotes stored in the first recycling chamber 15 is not greater than a predetermined number (whether it is not in a full state) (step S605).

When the number of the banknotes stored in the first recycling chamber 15 is not greater than the predetermined number (when it is not full) (step S605, Yes), the control unit 18 controls each unit to convey the deposited ten-dollar banknote to the first recycling chamber 15. After the recognition, the ten-dollar banknote is conveyed to and stored in the first recycling chamber 15 via the conveyance mechanism 6, the diversion mechanism 10, the diversion mechanism 11, the conveyance mechanism 8, and the conveyance mechanism 9 (step S606), and thus the depositing process is completed. Since the deposited ten-dollar banknote is set to be preferentially conveyed to the first recycling chamber 15, the deposited ten-dollar banknote is conveyed to the first recycling chamber 15 in this step.

When the number of the banknotes stored in the first recycling chamber 15 is greater than the predetermined number (when it is full) (step S605, No), the control unit 18 controls each unit to convey the deposited ten-dollar banknote to the collection chamber 7. After the recognition, the ten-dollar banknote is conveyed to and stored in the collection chamber 7 via the conveyance mechanism 6 and the diversion mechanism 10 (step S607), and thus the depositing process is completed.

When a ten-dollar banknote is present at the head in the second recycling chamber 16 (step S604, Yes), the control unit 18 confirms whether a ten-dollar banknote is present at the head in the first recycling chamber 15 (step S608). When the ten-dollar banknote is not present at the head in the first recycling chamber 15 (step S608, No), the control unit 18 controls each unit to convey the deposited ten-dollar banknote to the second recycling chamber 16. After the recognition, the ten-dollar banknote is conveyed to and stored in the second recycling chamber 16 via the conveyance mechanism 6, the diversion mechanism 10, the diversion mechanism 11, the conveyance mechanism 8, the diversion mechanism 12, and the conveyance mechanism 13 (step S609), and thus the depositing process is completed.

When a ten-dollar banknote is present at the head in the first recycling chamber 15 (step S608, Yes), the control unit 18 performs the control to convey the deposited ten-dollar banknote to the first recycling chamber 15. After the recognition, the ten-dollar banknote is conveyed to and stored in the first recycling chamber 15 via the conveyance mechanism 6, the diversion mechanism 10, the conveyance mechanism 8, the diversion mechanism 11, and the conveyance mechanism 9 (step S610), and thus the depositing process is completed. Since the deposited ten-dollar banknote is set to be preferentially conveyed to the first recycling chamber 15, the deposited ten-dollar banknote is conveyed to the first recycling chamber 15 in this step. Note that when the number of the banknotes stored in the first recycling chamber 15 is greater than the predetermined number (when it is full), the deposited ten-dollar banknote is conveyed to and stored in the collection chamber 7.

At this time, each unit may be controlled to convey the ten-dollar banknote stored at the head in the second recycling chamber 16 to the collection chamber 7. Alternatively, it is possible to perform the control to convey the ten-dollar banknote stored at the head in the second recycling chamber 16 to the first recycling chamber 15. Some of the ten-dollar banknotes stored at the head in the second recycling chamber 16 may be conveyed to the collection chamber 7, while storing other ones in the first recycling chamber 15. Some of the banknotes may be conveyed to the collection chamber 7 in such a manner that the number of ten-dollar banknotes stored at the head in the first recycling chamber 15 is equal to or greater than a predetermined number. Ten-dollar banknotes stored for long periods of time may be preferentially conveyed to the collection chamber 7 in accordance with the stored time. The movement process of the banknotes may be executed in the post-processing after the completion of the depositing process.

When the number of the banknotes stored in the second recycling chamber 16 is greater than the predetermined number (when it is full) (step S603, No), the control unit 18 confirms whether the number of the banknotes stored in the first recycling chamber 15 is not greater than the predetermined number (step S611). When the number of the banknotes stored in the first recycling chamber 15 is not greater than the predetermined number (step S611, Yes), each unit is controlled to convey the deposited ten-dollar banknote to the first recycling chamber 15. After the recognition, the ten-dollar banknote is conveyed to and stored in the first recycling chamber 15 via the conveyance mechanism 6, the diversion mechanism 10, the diversion mechanism 11, the conveyance mechanism 8, and the conveyance mechanism 9 (step S612), and thus the depositing process is completed.

On the other hand, when the number of the banknotes stored in the first recycling chamber 15 is greater than the predetermined number (when it is full) (step S611, No), each unit is controlled to convey the deposited ten-dollar banknote to the collection chamber 7. After the recognition, the ten-dollar banknote is conveyed to and stored in the collection chamber 7 via the conveyance mechanism 6 and the diversion mechanism 10 (step S607), and thus the depositing process is completed.

On the other hand, when the recognition result of the recognition unit 5 indicates that the banknote is not a ten-dollar banknote (step S602, No) but is a five-dollar banknote (step S613, Yes), the control unit 18 confirms whether the number of the banknotes stored in the first recycling chamber 15 is not greater than the predetermined number (step S614).

When the number of the banknotes stored in the first recycling chamber 15 is not greater than the predetermined number (step S614, Yes), the control unit 18 controls each unit to convey a five-dollar banknote to the first recycling chamber 15. After the recognition, the five-dollar banknote is conveyed to and stored in the first recycling chamber 15 via the conveyance mechanism 6, the diversion mechanism 10, the conveyance mechanism 8, the diversion mechanism 11, and the conveyance mechanism 9 (step S615), and thus the depositing process is completed.

When the number of the banknotes stored in the first recycling chamber 15 is greater than the predetermined number (when it is full) (step S614, No), the control unit 18 controls each unit to convey the deposited banknote to the collection chamber 7. After the recognition, the five-dollar banknote is conveyed to and stored in the collection chamber 7 via the conveyance mechanism 6 and the diversion mechanism 10 (step S616), and thus the depositing process is completed.

On the other hand, when the recognition result of the recognition unit 5 indicates that the banknote is a one-dollar banknote (step S617, Yes), the control unit 18 confirms whether the number of the banknotes stored in the second recycling chamber 16 is not greater than the predetermined number (step S618).

When the number of the banknotes stored in the second recycling chamber 16 is not greater than the predetermined number (step S618, Yes), the control unit 18 controls each unit to convey the deposited one-dollar banknote to the second recycling chamber 16. After the recognition, the one-dollar banknote is conveyed to and stored in the second recycling chamber 16 via the conveyance mechanism 6, the diversion mechanism 10, the diversion mechanism 11, the conveyance mechanism 8, the diversion mechanism 12, and the conveyance mechanism 13 (step S619), and thus the depositing process is completed.

When the number of the banknotes stored in the second recycling chamber 16 is greater than the predetermined number (when it is full) (step S618, No), the control unit 18 controls each unit to convey the deposited one-dollar banknote to the collection chamber 7. After the recognition, the one-dollar banknote is conveyed to and stored in the collection chamber 7 via the conveyance mechanism 6 and the diversion mechanism 10 (step S620), and thus the depositing process is completed. In addition, also when the recognition result of the recognition unit 5 indicates that it is not a one-dollar banknote (step S617, No), the deposited banknote is conveyed to and stored in the collection chamber 7 (step S620), and thus the depositing process is completed.

After the depositing process, as immediately after the dispensing process in the third embodiment, the first recycling chamber 15 stores five-dollar banknotes and ten-dollar banknotes in a mixed state, and the second recycling chamber 16 stores one-dollar banknotes and in some cases stores one-dollar banknotes and ten-dollar banknotes in a mixed state.

Note that when a ten-dollar banknote is deposited, the number of ten-dollar banknotes stored on the head side than the five-dollar banknote closest to the head in the first recycling chamber 15 may be confirmed. In the case where a predetermined number or more of ten-dollar banknotes are already stored on the head side than the five-dollar banknote, the deposited ten-dollar banknote may be conveyed to the collection chamber 7 without conveying it to the first recycling chamber 15. Likewise, in the case where a predetermined number or more of ten-dollar banknotes are stored on the head side than the one-dollar banknote closest to the head in the second recycling chamber 16, the deposited ten-dollar banknote may be conveyed to the collection chamber 7. Alternatively, whether to convey the deposited ten-dollar banknote to the collection chamber 7 may be determined based on whether the sum of the numbers of ten-dollar banknotes located on the head side in the first recycling chamber 15 and the second recycling chamber 16 is smaller than a predetermined number. In this manner, when dispensing five-dollar banknotes, the increase in dispense time due to the conveyance of a large number of unnecessary ten-dollar banknotes to the collection chamber 7 can be suppressed.

In addition, in the case where a ten-dollar banknote is stored at the head in the first recycling chamber 15 and in the second recycling chamber 16, the storage destination of the deposited ten-dollar banknote may be determined in accordance with the number of ten-dollar banknotes located on the head side in the first recycling chamber 15 and the second recycling chamber 16 instead of storing the deposited ten-dollar banknote in the first recycling chamber 15. It may be stored in the chamber of which the number of ten-dollar banknotes on the head side is smaller. In this case, the number of ten-dollar banknotes to be moved can be equalized for both the one-dollar banknotes and the five-dollar banknotes to be dispensed. They may be stored in the chamber of which the number of ten-dollar banknotes on the head side. In this case, the ten-dollar banknote can be collectively stored as much as possible. Thereafter, the ten-dollar banknotes stored on the head side in the recycling chamber of which the number of ten-dollar banknotes stored on the head side is smaller may be conveyed to the collection chamber 7 in a period between transactions.

In the present embodiment, the ten-dollar banknote is preferentially conveyed to the first recycling chamber 15 that preferentially stores the five-dollar banknote as the higher-denomination of the five-dollar banknote and one-dollar banknote, but the setting of the recycling chamber for the preferential conveyance is not limited to this. Other denominations may be determined to be preferentially mixed in a recycling chamber for recycling banknotes of a denomination that is less frequently dispensed. On the basis of the positional relationship with the collection chamber, other denominations may be preferentially conveyed to the recycling chamber closer to the collection chamber than the other. It may be determined by the user's selection.

In addition, in this flowchart, whether each recycling chamber is not in a full state is determined based on whether the number of stored sheets is not greater than the predetermined number, but it may be determined based on a detection state of the full detection sensor provided in each recycling chamber. In addition, both the determination based on the number of sheets and the determination based on the full detection sensor may be adopted.

### Dispensing Process

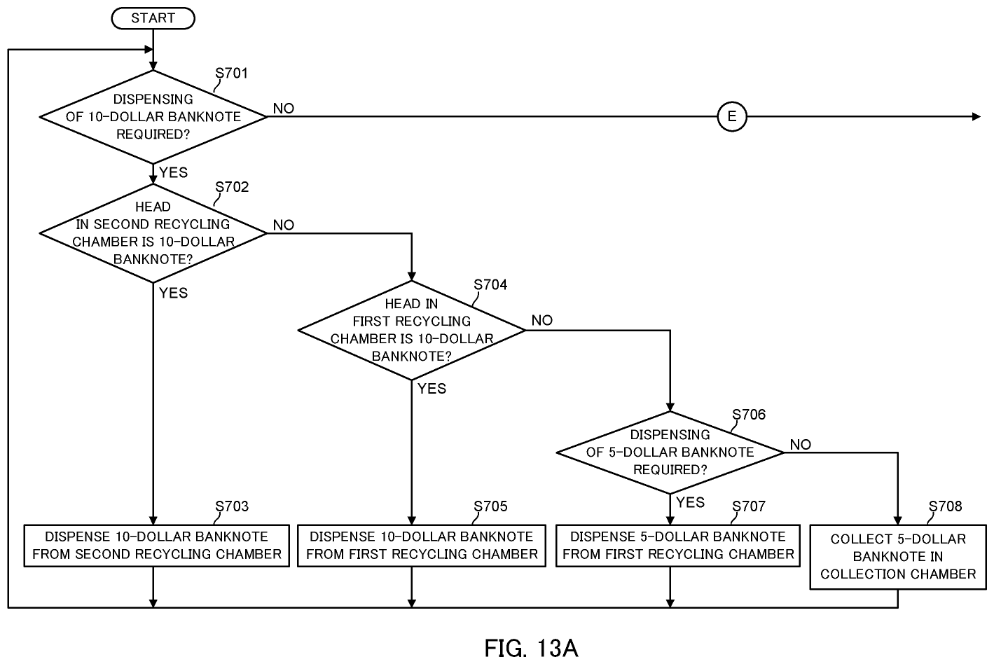

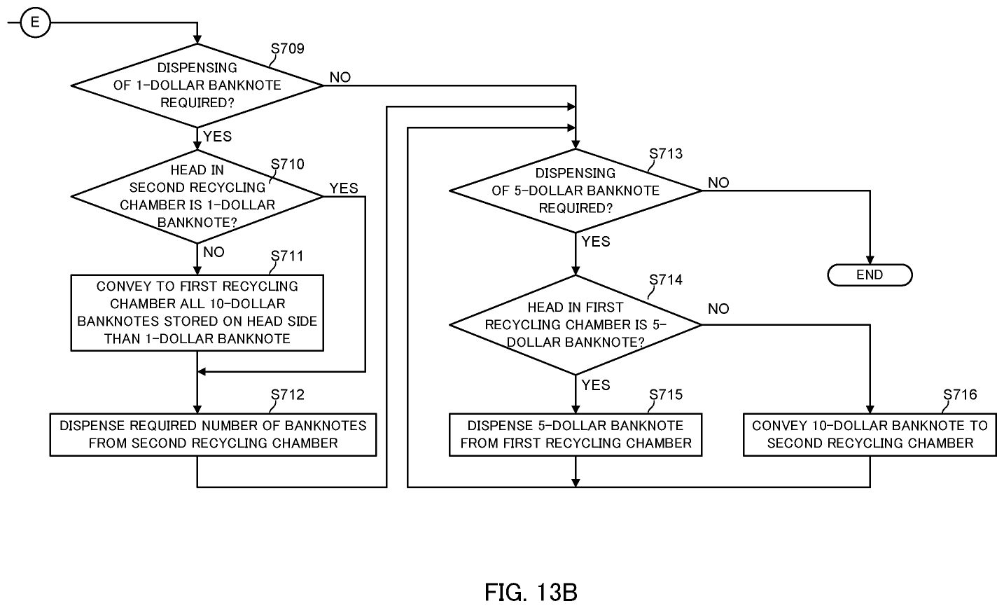

Next, a method of a dispensing process of the banknote is described. FIGS. 13A and 13B are flowcharts illustrating a method of dispensing a banknote using the sheet processing apparatus 1 according to the fourth embodiment. Note that in this dispensing process, the first recycling chamber 15 stores five-dollar banknotes and ten-dollar banknotes in a mixed state, and the second recycling chamber 16 stores one-dollar banknotes and in some cases stores one-dollar banknotes and ten-dollar banknotes in a mixed state. Note that in this flowchart, after a banknote of the denomination as the dispensing target included in a request of the dispensing process is dispensed, it is excluded from the dispensing target in the next step.

First, when receiving a request of the dispensing process, the control unit 18 determines whether it is necessary to dispense a ten-dollar banknote (whether it is the dispensing target) (step S701).

When it is necessary to dispense a ten-dollar banknote (step S701, Yes), the control unit 18 confirms whether a ten-dollar banknote is present at the head in the second recycling chamber 16 (step S702).

When a ten-dollar banknote is present at the head in the second recycling chamber 16 (step S702, Yes), the control unit 18 controls each unit to convey the ten-dollar banknote from the second recycling chamber 16 to the outlet part 14. The ten-dollar banknote is conveyed to the outlet part 14 via the conveyance mechanism 13, the diversion mechanism 12, and the conveyance mechanism 8 and dispensed (step S703).

On the other hand, when the ten-dollar banknote is not present at the head in the second recycling chamber 16 (step S702, No), the control unit 18 confirms whether a ten-dollar banknote is present at the head in the first recycling chamber 15 (step S704).

When a ten-dollar banknote is present at the head in the first recycling chamber 15 (step S704, Yes), the control unit 18 controls each unit to convey a ten-dollar banknote from the first recycling chamber 15 to the outlet part 14. The ten-dollar banknote is conveyed to the outlet part 14 via the conveyance mechanism 9, the diversion mechanism 11, and the conveyance mechanism 8 and dispensed (step S705). The process is returned to step S701.

When the ten-dollar banknote is not present at the head in the first recycling chamber 15, that is, when there is a five-dollar banknote (step S704, No), the control unit 18 determines whether it is necessary to dispense a five-dollar banknote (whether it is the dispensing target) (step S706). When it is necessary to dispense a five-dollar banknote (step S706, Yes), the control unit 18 controls each unit to convey a five-dollar banknote from the first recycling chamber 15 to the outlet part 14. The five-dollar banknote is conveyed to the outlet part 14 via the conveyance mechanism 9, the diversion mechanism 11, and the conveyance mechanism 8 and dispensed (step S707).

When it is not necessary dispense the five-dollar banknote (non-dispensing target) (step S706, No), the control unit 18 controls each unit to convey a five-dollar banknote from the first recycling chamber 15 to the collection chamber 7. The five-dollar banknote is conveyed to and stored in the collection chamber 7 via the conveyance mechanism 9, the diversion mechanism 11, the conveyance mechanism 8, and the conveyance mechanism 6 (step S708). The process is returned to step S701.

Thereafter, when the processes of steps S701 to S708 are repeated and finally when it is not necessary to dispense a ten-dollar banknote (step S701, No), the control unit 18 determines whether it is necessary to dispense a one-dollar banknote (step S709).

When it is necessary to dispense a one-dollar banknote (step S709, Yes), the control unit 18 confirms whether a one-dollar banknote is located at the head in the second recycling chamber 16 (step S710).

In the case where the one-dollar banknote is not present at the head in the second recycling chamber 16, that is, when there is a ten-dollar banknote (step S710, No), the control unit 18 controls each unit to convey to the first recycling chamber 15 all ten-dollar banknotes stored on the head side than the one-dollar banknote in the second recycling chamber 16. The ten-dollar banknote is conveyed to and stored in the first recycling chamber 15 via the conveyance mechanism 13, the diversion mechanism 12, the conveyance mechanism 8, the diversion mechanism 11, and the conveyance mechanism 9 (step S711).

As a result, a one-dollar banknote is stored at the head in the second recycling chamber 16, and thus the control unit 18 controls each unit to convey a required number of one-dollar banknotes from the second recycling chamber 16 to the outlet part 14. The one-dollar banknote is conveyed to the outlet part 14 via the conveyance mechanism 13, the diversion mechanism 12, and the conveyance mechanism 8 and dispensed (step S712).

Also when a one-dollar banknote is present at the head in the second recycling chamber 16 (step S710, Yes), the process proceeds to step S712.

When it is not necessary to dispense the one-dollar banknote (step S709, No), or when the dispensing of the one-dollar banknote is completed (step S712), the control unit 18 determines whether it is necessary to dispense a five-dollar banknote (step S713).

When it is necessary to dispense a five-dollar banknote (step S713, Yes), the control unit 18 confirms whether a five-dollar banknote is present at the head in the first recycling chamber 15 (step S714).

When a five-dollar banknote is present at the head in the first recycling chamber 15 (step S714, Yes), the control unit 18 controls each unit to convey a five-dollar banknote from the first recycling chamber 15 to the outlet part 14. The five-dollar banknote is conveyed to the outlet part 14 via the conveyance mechanism 9, the diversion mechanism 11, and the conveyance mechanism 8 and dispensed (step S715). The process is returned to step S713.

When the five-dollar banknote is not present at the head in the first recycling chamber 15, that is, when there is a ten-dollar banknote (step S714, No), the control unit 18 controls each unit to convey the head ten-dollar banknote to the second recycling chamber 16. The ten-dollar banknote is conveyed to and stored in the second recycling chamber 16 via the conveyance mechanism 9, the diversion mechanism 11, the conveyance mechanism 8, the diversion mechanism 12, and the conveyance mechanism 13 (step S716). The process is returned to step S713.

Steps S713 to S716 are repeated until the required number of five-dollar banknotes is dispensed.

Finally, when it is not necessary to dispense a five-dollar banknote (step S713, No), all banknotes requested to be dispensed have been dispensed, and the dispensing process is completed.

After the dispensing process, as in a post depositing process state, the first recycling chamber 15 stores five-dollar banknotes and ten-dollar banknotes in a mixed state, and the second recycling chamber 16 stores one-dollar banknotes and in some cases stores one-dollar banknotes and ten-dollar banknotes in a mixed state.

Note that when the five-dollar banknote is not present at the head in the first recycling chamber 15, that is, when there is a ten-dollar banknote (step S714, No), the ten-dollar banknote is conveyed to the second recycling chamber 16 at step S716, but it is also possible to convey it to the collection chamber 7 when the number of ten-dollar banknotes stored in the second recycling chamber 16 is greater than a predetermined number. As a result, the speed in the dispensing process can be maintained within a predetermined range.

In addition, the dispensing order is not limited to the order of the present embodiment. It is possible to dispense the one-dollar banknote first, and then whether it is necessary to dispense a ten-dollar banknote may be determined on an as-needed basis when a ten-dollar banknote is present in the middle of the process. It is possible to dispense the five-dollar banknote first, and then whether it is necessary to dispense a ten-dollar banknote may be determined on an as-needed basis when a ten-dollar banknote is present in the middle of the process.

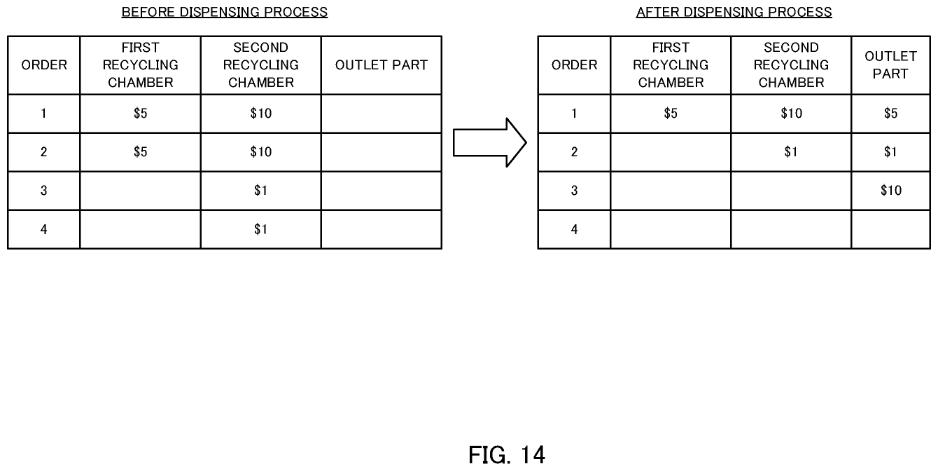

FIG. 14 is a diagram illustrating an example case where how a banknote is conveyed in a dispensing process. In this example, a total of 16 dollars are dispensed. First, one ten-dollar banknote is dispensed from the second recycling chamber 16. Thereafter, one ten-dollar banknote is moved from the second recycling chamber 16 to the first recycling chamber 15, and one one-dollar banknote is dispensed from the second recycling chamber 16. Thereafter, one ten-dollar banknote is again moved from the first recycling chamber 15 to the second recycling chamber 16, and one five-dollar banknote is dispensed from the first recycling chamber 15.

In this manner, with the sheet processing apparatus according to the fourth embodiment, the depositing process and the dispensing process can be performed in the state where a ten-dollar banknote is stored not only in the first recycling chamber 15, but also in the second recycling chamber 16. In this manner, the conveyance destination of the depositing banknotes can be changed in accordance with the states of the previously stored banknotes of three types (stored locations and the number of sheets), and thus the efficiency of the dispensing process can be increased. Further, since the dispensing order can be controlled to reduce the movement of banknotes in accordance with the states of the stored banknotes of three types (stored locations and the number of sheets), the occurrence of jam due to skewing of banknotes during movement and the like can be reduced.

### Fifth Embodiment

Next, a sheet processing apparatus of a fifth embodiment of the present disclosure is described. In the fifth embodiment, a sensor is provided the conveyance path between the first recycling chamber and the second recycling chamber to detect the portion where the banknote passing through it passes in the conveyance path. The banknote having been deviated left or right in the conveyance path beyond the assumption is collected to the collection chamber.

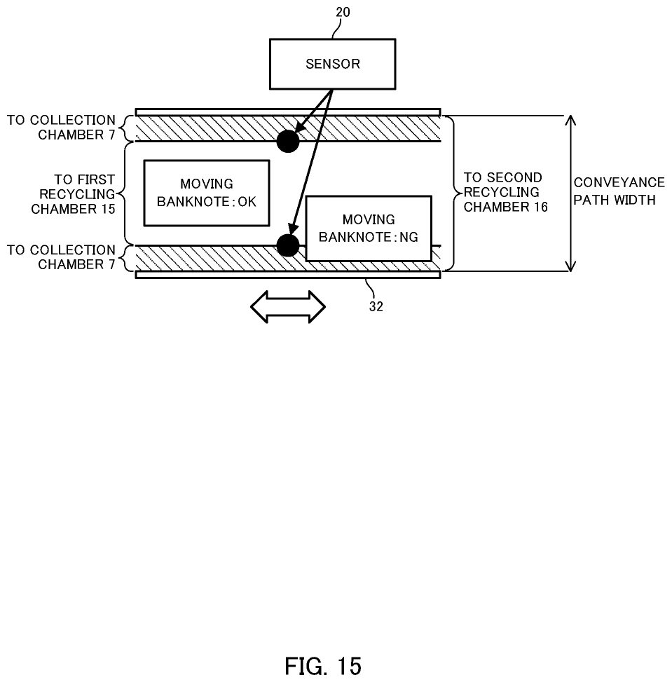

FIG. 15 is a diagram for describing detection of a left/right deviation of a banknote by a sensor 20. The sensor 20 detects whether the banknote being conveyed is deviated left or right with respect to the conveyance path. The sensor 20 is disposed in the conveyance mechanism 8 between the first recycling chamber 15 and the second recycling chamber 16. More specifically, the sensor 20 is disposed near both ends of the conveyance path between the first recycling chamber 15 (the diversion mechanism 11) and the second recycling chamber 16 (the diversion mechanism 12) in the conveyance mechanism 8.

When the banknote moving between the first recycling chamber 15 and the second recycling chamber 16 deviates right or left with respect to the width of the conveyance path beyond the assumption, the control unit 18 controls each unit to convey the banknote to the collection chamber 7.

In this manner, with the sheet processing apparatus according to the fifth embodiment, the banknote deviated left or right beyond the assumption can be conveyed to the collection chamber with the sensor disposed at the banknote conveyance path, and thus the jam rate can be reduced.

Note that in the present embodiment, whether to convey the banknote to the collection chamber 7 is determined based on the detection of the portion where the banknote passes in the conveyance path by the sensor 20, the number of times the banknote moves back and forth between the first recycling chamber 15 and the second recycling chamber 16 may be set in advance so as to convey the banknote that has reached the set number of times to the collection chamber 7.

The first recycling chamber and the second recycling chamber of the first embodiment may be a stacking type storage that stores banknotes in a staking manner in the vertical direction.

In the first to fifth embodiments, two recycling chambers are provided, but three or more recycling chambers may be provided. In the case where three or more recycling chambers are provided, banknotes of up to six types can be recycled. In either case, the recycling chamber is connected to the second conveyance mechanism.

In the second to fifth embodiments, banknotes of the non-dispensing target are moved between the recycling chambers, but they may be stored in a location other than the recycling chamber, e.g., a location where the conveyance drive is divided in the conveyance path, and a replenishment IF cassette, and may be returned to the recycling chamber after the dispensing process.

The sheet processing apparatus of the present disclosure is not limited to the embodiments described in detail so far, and various modifications to the extent that the intent is not departed from are also included in the sheet processing apparatus of the present disclosure.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A sheet processing apparatus, comprising:
an inlet configured to receive a sheet;
an outlet configured to eject the sheet;
a conveyance mechanism configured to convey the sheet between the inlet and the outlet;
a recognition unit configured to recognize the sheet; and
at least one recycling chamber configured to store the sheet,
wherein the conveyance mechanism comprises:
a first conveyance mechanism configured to convey downward the sheet received from the inlet, and
a second conveyance mechanism connecting between the first conveyance mechanism and the outlet and configured to convey upward the sheet conveyed from the first conveyance mechanism,
wherein the recognition unit is disposed on a conveyance path on which the sheet is conveyed by the first conveyance mechanism, and
wherein the at least one recycling chamber is connected to the second conveyance mechanism.

2. The sheet processing apparatus according to claim 1, wherein the recognition unit and the at least one recycling chamber are disposed at positions that differ in a height direction.

3. The sheet processing apparatus according to claim 2, wherein the recognition unit is disposed at a position higher than the at least one recycling chamber.

4. The sheet processing apparatus according to claim 1, further comprising a three-direction diversion mechanism configured to convey the sheet with a diversion in a horizontal direction from the second conveyance mechanism, the three-direction diversion mechanism being connected to one of the at least one recycling chamber.

5. The sheet processing apparatus according to claim 1, further comprising a collection chamber configured to store a sheet that is not used for dispensing, the collection chamber being located below the inlet, the outlet, the conveyance mechanism, the recognition unit, and the at least one recycling chamber.

6. The sheet processing apparatus according to claim 1,
wherein the first conveyance mechanism is disposed on a depth side of the sheet processing apparatus, and
wherein the second conveyance mechanism is disposed on a near side of the sheet processing apparatus.

7. The sheet processing apparatus according to claim 1, further comprising a horizontal conveyance mechanism connecting between the inlet and the first conveyance mechanism.

8. The sheet processing apparatus according to claim 1, further comprising a three-direction diversion mechanism disposed between the at least one recycling chamber and the second conveyance mechanism, and configured for diversion of the sheet.

9. The sheet processing apparatus according to claim 8, wherein the diversion of the sheet is performed by the three-direction diversion mechanism such that the diversion is switched based on a conveyance destination of a next sheet in response to detection of passage of a previously conveyed sheet.

10. The sheet processing apparatus according to claim 4, wherein the at least one recycling chamber comprises a plurality of recycling chambers,
wherein each of the plurality of recycling chambers is connected to one three-direction diversion mechanism, and connected to the second conveyance mechanism.

11. The sheet processing apparatus according to claim 1, further comprising a control unit configured to feed and convey one sheet from the at least one recycling chamber to the recognition unit, and stop conveyance of the sheet after the sheet passes through the recognition unit when reconciliation of the sheet stored in the at least one recycling chamber is performed.

12. The sheet processing apparatus according to claim 1, further comprising:
a plurality of storage chambers including the at least one recycling chamber; and
a control unit,
wherein the control unit is configured to store sheets of a first denomination and a second denomination in a first recycling chamber of the at least one recycling chamber, and
wherein when the sheet of the second denomination is inserted from the inlet, and a predetermined number or more of sheets of the second denomination are stored at a head in the first recycling chamber, the control unit conveys the inserted sheet of the second denomination to a collection chamber configured to store the sheet that is not used for dispensing.

13. The sheet processing apparatus according to claim 12, wherein when dispensing the sheet to the outlet, the control unit conveys a sheet of a denomination that is unnecessary for the dispensing from the first recycling chamber to a storage chamber that is different from the first recycling chamber.

14. The sheet processing apparatus according to claim 13, wherein the storage chamber that is different from the first recycling chamber is the collection chamber configured to store the sheet that is not used for dispensing.

15. The sheet processing apparatus according to claim 14, wherein the storage chamber that is different from the first recycling chamber is a second recycling chamber configured to store a sheet of a third denomination in a recyclable manner.
